(19) United States
(12) Patent Application Publication
(10) Pub. No.: US 2024/0408909 A1
(43) Pub. Date: Dec. 12, 2024

(54) RECORDING MEDIUM, CARD, AND BOOKLET

(71) Applicant: Sony Group Corporation, Tokyo (JP)

(72) Inventors: Yuriko KAINO, Tokyo (JP); Kenichi KURIHARA, Tokyo (JP); Ayumi KAI, Tokyo (JP)

(21) Appl. No.: 18/689,766

(22) PCT Filed: Mar. 31, 2022
(86) PCT No.: PCT/JP2022/016419

§ 371 Date: Mar. 6, 2024

(30) Foreign Application Priority Data
Sep. 21, 2021 (JP) 2021-153590

(51) Int. Cl. B41M 5/34; B41M 5/333; B42D 25/41

(52) U.S. Cl. CPC B41M 5/34; B41M 5/3333; B42D 25/41; B41M 2205/04

(57) ABSTRACT

To provide a recording medium capable of improving color development retention characteristics during high-temperature and high-humidity preservation and suppressing color development of a background.

The recording medium includes a recording layer that includes a coloring compound with electron-donating properties, and a color developer with electron acceptability. The color developer includes a compound represented by the following formula (1).

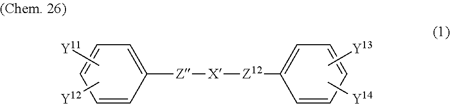

(wherein, in the formula (1), X¹ represents a divalent group that has at least one benzene ring. Y¹¹, Y¹², Y¹³, and Y¹⁴ independently represent a monovalent group. Z¹¹ and Z¹² independently represent a hydrogen-bonding group.)

### TECHNICAL FIELD

The present disclosure relates to a recording medium, a card including the same, and a booklet.

### BACKGROUND ART

In recent years, as a recording medium to replace a printed matter, a recording medium including a coloring compound with electron-donating properties and a color developer with electron acceptability has been developed. Patent Literature 1 describes using a bis(hydroxybenzoic acid) compound (bisurea compound) represented by a specific formula as a color developer.

### CITATION LIST

### Patent Literature

Patent Literature 1: Japanese Patent Application Laid-open No. 1996-244355

### DISCLOSURE OF INVENTION

### Technical Problem

In recent years, a recording medium that includes a coloring compound and a color developer is desired to improve color development retention characteristics in a high-temperature and high-humidity environment and suppress coloration of an unrecorded area (hereinafter, referred to as a “background” in some cases). However, Patent Literature 1 does not consider color development retention characteristics in a high-temperature and high-humidity environment.

It is an object of the present disclosure to provide a recording medium capable of improving color development retention characteristics during high-temperature and high-humidity preservation and suppressing color development of a background, a card including the same, and a booklet.

### Solution to Problem

In order to achieve the above-mentioned object, a first disclosure is a recording medium, including:
a recording layer that includes a coloring compound with electron-donating properties and a color developer with electron acceptability,
the color developer including a compound represented by the following formula (1).

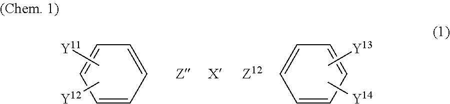

(wherein, in the formula (1), X¹ represents a divalent group that has at least one benzene ring. Y¹¹, Y¹², Y¹³, and Y¹⁴ independently represent a monovalent group. Z¹¹ and Z¹² independently represent a hydrogen-bonding group.)

A second disclosure is a recording medium, including:
a recording layer that includes a coloring compound with electron-donating properties and a color developer with electron acceptability,
the color developer including a compound represented by the following formula (a).

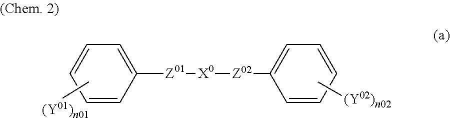

(wherein, in the formula (a), X⁰ represents a divalent group that has at least one benzene ring. Y⁰¹ and Y⁰² independently represent a monovalent group. n01 and n02 independently represent an integer from 0 to 5. When n01 represents an integer from 2 to 5, each Y⁰¹ may be the same or different. When n02 represents an integer from 2 to 5, Y⁰² may be the same or different. Z⁰¹ and Z⁰² independently represent a hydrogen-bonding group.)

A third disclosure is a card including the recording medium according to the first or second disclosure.

A fourth disclosure is a booklet including the recording medium according to the first or second disclosure.

### BRIEF DESCRIPTION OF DRAWINGS

FIG. 1 is a cross-sectional view showing an example of a configuration of a recording medium according to a first embodiment.

FIG. 2 is a cross-sectional view showing an example of a configuration of a recording medium according to a second embodiment.

FIG. 3 is a cross-sectional view showing an example of a configuration of a recording medium according to a third embodiment.

FIG. 4 is a perspective view showing an example of a configuration of a stacked body according to a fourth embodiment.

FIG. 5 is a cross-sectional view taken along the line V-V in FIG. 4.

FIG. 6 is a cross-sectional view showing an example of a configuration of a stacked body according to a fifth embodiment.

FIG. 7 Part A of FIG. 7 is a plan view showing an example of the appearance of an application example 1. Part B of FIG. 7 is a cross-sectional view taken along the line VIIB-VIIB in Part A of FIG. 7.

FIG. 8 is a perspective view showing an example of the appearance of an application example 2.

FIG. 9 Part A of FIG. 9 is a plan view showing an example of the appearance (front surface side) of an application example 3. Part B of FIG. 9 is a plan view showing an example of the appearance (back surface side) of the application example 3.

FIG. 10 Part A of FIG. 10 is a plan view showing an example of the appearance (front surface side) of an application example 4. Part B of FIG. 10 is a plan view showing an example of the appearance (back surface side) of the application example 4.

FIG. 11 Part A of FIG. 11 is a perspective view showing an example of the appearance (front surface side) of an application example 5. Part B of FIG. 11 is a perspective view showing an example of the appearance (back surface side) of the application example 5.

FIG. 12 Part A of FIG. 12 is a plan view showing an example of the appearance (first surface side) of an application example 6. Part B of FIG. 12 is a plan view showing an example of the appearance (second surface side) of the application example 6.

FIG. 13 Part A of FIG. 13 is a plan view showing an example of the appearance (top surface side) of an application example 7. Part B of FIG. 13 is a plan view showing an example of the appearance (side surface side) of the application example 7.

FIG. 14 is a plan view showing an example of the appearance of an application example 8.

FIG. 15 is a perspective view showing an example of the appearance of an application example 9.

FIG. 16 Part A of FIG. 16 is a plan view showing an example of the appearance of an application example 10. Part B of FIG. 16 is a cross-sectional view taken along the line XVIB-XVIB in Part A of FIG. 16.

### MODE(S) FOR CARRYING OUT THE INVENTION

Embodiments of the present disclosure will be described in the following order. Note that in all the drawings of the following embodiments, the same or corresponding portions will be denoted by the same reference symbols.
1 First embodiment (example of recording medium)
   1.1 Configuration of recording medium
   1.2 Recording method of recording medium
   1.3 Method of producing recording medium
   1.4 Operation and effect
2 Second embodiment (Example of recording medium)
   2.1 Configuration of recording medium
   2.2 Recording method of recording medium
   2.3 Operation and effect
3 Third embodiment (example of recording medium)
   3.1 Configuration of recording medium
   3.2 Recording method of recording medium
   3.3 Operation and effect
4 Fourth embodiment (example of stacked body)
   4.1 Configuration of recording medium
   4.2 Method of producing recording medium
   4.3 Operation and effect
5 Fifth embodiment (example of stacked body)
   5.1 Configuration of recording medium
   5.2 Method of producing recording medium
   5.3 Operation and effect
6 Modified examples
7 Application examples
8 Examples

In the present specification, “and/or” means at least one of them. For example, in the case of “X and/or Y”, it means three types: only X, only Y, and X and Y.

### 1 First Embodiment

### [1.1 Configuration of Recording Medium]

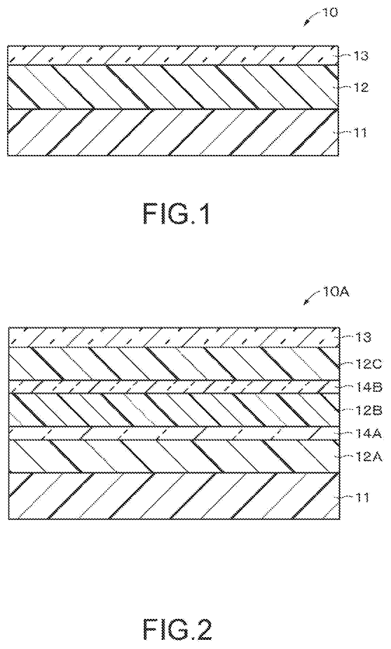

Hereinafter, an example of a configuration of a recording medium 10 according to a first embodiment will be described with reference to FIG. 1. The recording medium 10 is configured such that its coloring state can be changed by irradiation of laser light (external stimulation). By using the change in coloring state, an image or the like can be drawn on the recording medium 10. Here, the image includes not only an image such as a design, a color pattern, and a photograph, but also a text such as a character and a symbol.

The laser light is favorably near-infrared laser light. The change in coloring state may be a reversible change or an irreversible change. That is, the recording medium 10 may be rewritable, in which an image or the like can be rewritten, or write-once, in which an image or the like can be written only once. From the viewpoint of anti-tamper properties, the change in coloring state is favorably an irreversible change.

The recording medium 10 includes a base material 11 and a recording layer 12 provided on the base material 11. The recording medium 10 may further include a protective layer 13 provided on the recording layer 12. Hereinafter, the base material 11, the recording layer 12, and the protective layer 13 will be described in order.

### (Base Material)

The base material 11 is a support for supporting the recording layer 12. The base material 11 is favorably formed of a material having excellent heat resistance and excellent dimension stability in the planar direction. The base material 11 may have either optical transparency or non-optical transparency. The base material 11 may have a predetermined color such as white. The base material 11 has, for example, a plate shape or a film shape. In the present disclosure, the film is defined to include a sheet.

The base material 11 may have, for example, rigidity or flexibility. In the case where the base material 11 having flexibility is used, it is possible to realize a flexible recording medium 10. Examples of the base material 11 having rigidity include a wafer and a glass substrate. Examples of the base material 11 having flexibility include flexible glass, a film, and paper.

Examples of the constituent material of the base material 11 include an inorganic material, a metal material, and a polymer material. Two or more of the inorganic material, the metal material, the polymer material, and the like may be combined. In the case where two or more constituent materials are combined, the two or more constituent materials may be stacked. In the case where an inorganic material and a polymer material are combined, particles of the inorganic material may be dispersed and contained in the polymer film. Similarly, also in the case where a metal material and a polymer material are combined, particles of the metal material may be dispersed and contained in the polymer film.

The inorganic material includes, for example, at least one selected from the group consisting of silicon (Si), silicon oxide (SiOx), silicon nitride (SiNx), and aluminum oxide (AlOx). The silicon oxide includes, for example, at least one selected from the group consisting of glass and spin-on glass (SOG). The metal material includes, for example, at least one selected from the group consisting of aluminum (Al), nickel (Ni), and stainless steel. The polymer material includes, for example, at least one selected from the group consisting of polycarbonate (PC), polyethylene terephthalate (PET), polyethylene naphthalate (PEN), polyethyletherketone (PEEK), and polyvinyl chloride (PVC).

Note that a reflective layer (not shown) may be provided on at least one main surface of the base material 11, or the base material 11 itself may have a function as a reflective layer. When the base material 11 has such a configuration, clearer color display is possible.

### (Recording Layer)

The recording layer 12 in an unrecorded state (initial state) is in a decolored state. The state of the recording layer 12 can be changed from the decolored state to a colored state by irradiation of laser light. The recording layer 12 is capable of exhibiting a predetermined color in the colored state. Examples of the predetermined color include, but not limited to, black, cyan, magenta, yellow, red, green, and blue.

The thickness of the recording layer 12 is favorably 1 μm or more and 20 μm or less, more favorably 2 μm or more and 15 μm or less. When the thickness of the recording layer 12 is 1 μm or more, it is possible to achieve sufficient color density. Meanwhile, in the case where the thickness of the recording layer 12 is 20 μm or less, it is possible to prevent the heat utilization amount of the recording layer 12 from becoming too large. Therefore, it is possible to prevent the color development from deteriorating.

The recording layer 12 includes a coloring compound with electron-donating properties and a color developer with electron acceptability. The recording layer 12 favorably further includes at least one selected from the group consisting of a photothermal conversion agent and a matrix resin.

### (Coloring Compound)

The coloring compound is capable of developing color by reacting with a color developer. The coloring compound is, for example, a leuco dye. When a lactone ring included in the molecule of the leuco dye reacts with a compound with electron acceptability such as an acid, the lactone ring opens to develop color. When the opened lactone ring in the leuco dye reacts with a base, it may be closed and may lose its color. The leuco dye may be, for example, an existing dye for thermal paper. The leuco dye may be, for example, an existing dye for thermal paper. Specific examples of the leuco dye include a compound having a group with electron-donating properties in the molecule, which is represented by the following formula (2).

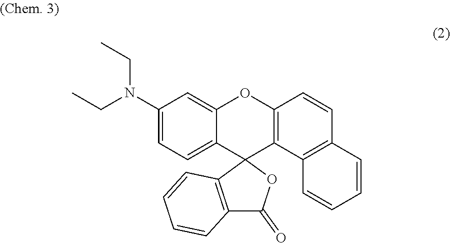 [SMILES: CCN(CC)c1ccc2c(c1)Oc1ccc3ccccc3c1C21OC(=O)c2ccccc21]

The coloring compound is not particularly limited and can be appropriately selected in accordance with the purpose. Specific examples of the coloring compound include a fluorane compound, a triphenylmethanephthalide compound, an azaphthalide compound, a phenothiazine compound, a leuco auramine compound, and an indolinophthalide compound. In addition, examples thereof include 2-anilino-3-methyl-6-diethylaminofluorane, 2-anilino-3-methyl-6-di (n-butylamino) fluorane, 2-anilino-3-methyl-6-(N-n-propyl-N-methylamino)fluorane, 2-anilino-3-methyl-6-(N-isopropyl-N-methylamino)fluorane, 2-anilino-3-methyl-6-(N-isobutyl-N-methylamino)fluorane, 2-anilino-3-methyl-6-(N-n-amyl-N-methylamino)fluorane, 2-anilino-3-methyl-6-(N-sec-butyl-N-methylamino)fluorane, 2-anilino-3-methyl-6-(N-n-amyl-N-ethylamino)fluorane, 2-anilino-3-methyl-6-(N-iso-amyl-N-ethylamino)fluorane, 2-anilino-3-methyl-6-(N-n-propyl-N-isopropylamino)fluorane, 2-anilino-3-methyl-6-(N-cyclohexyl-N-methylamino)fluorane, 2-anilino-3-methyl-6-(N-ethyl-p-toluidino)fluorane, 2-anilino-3-methyl-6-(N-methyl-p-toluidino)fluorane, 2-(m-trichloromethylanilino)-3-methyl-6-diethylaminofluorane, 2-(m-trifluoromethylanilino)-3-methyl-6-diethylaminofluorane, 2-(m-trichloromethylanilino)-3-methyl-6-(N-cyclohexyl-N-methylamino)fluorane, 2-(2,4-dimethylanilino)-3-methyl-6-diethylaminofluorane, 2-(N-ethyl-p-toluidino)-3-methyl-6-(N-ethylanilino)fluorane, 2-(N-ethyl-p-toluidino)-3-methyl-6-(N-propyl-p-toluidino)fluorane, 2-anilino-6-(N-n-hexyl-N-ethylamino)fluorane, 2-(o-chloroanilino)-6-diethylaminofluorane, 2-(o-chloroanilino)-6-dibutylaminofluorane, 2-(m-trifluoromethylanilino)-6-diethylaminofluorane, 2,3-dimethyl-6-dimethylaminofluorane, 3-methyl-6-(N-ethyl-p-toluidino)fluorane, 2-chloro-6-diethylaminofluorane, 2-bromo-6-diethylaminofluorane, 2-chloro-6-dipropylaminofluorane, 3-chloro-6-cyclohexylaminofluorane, 3-bromo-6-cyclohexylaminofluorane, 2-chloro-6-(N-ethyl-N-isoamylamino)fluorane, 2-chloro-3-methyl-6-diethylaminofluorane, 2-anilino-3-chloro-6-diethylaminofluorane, 2-(o-chloroanilino)-3-chloro-6-cyclohexylaminofluorane, 2-(m-trifluoromethylanilino)-3-chloro-6-diethylaminofluorane, 2-(2,3-dichloroanilino)-3-chloro-6-diethylaminofluorane, 1,2-benzo-6-diethylaminofluorane, 3-diethylamino-6-(m-trifluoromethylanilino)fluorane, 3-(1-ethyl-2-methylindol-3-yl)-3-(2-ethoxy-4-diethylaminophenyl)-4-azaphthalide, 3-(1-ethyl-2-methylindol-3-yl)-3-(2-ethoxy-4-diethylaminophenyl)-7-azaphthalide, 3-(1-octyl-2-methylindol-3-yl)-3-(2-ethoxy-4-diethylaminophenyl)-4-azaphthalide, 3-(1-ethyl-2-methylindol-3-yl)-3-(2-methyl-4-diethylaminophenyl)-4-azaphthalide, 3-(1-ethyl-2-methylindol-3-yl)-3-(2-methyl-4-diethylaminophenyl)-7-azaphthalide, 3-(1-ethyl-2-methylindol-3-yl)-3-(4-diethylaminophenyl)-4-azaphthalide, 3-(1-ethyl-2-methylindol-3-yl)-3-(4-N-n-amyl-N-methylaminophenyl)-4-azaphthalide, 3-(1-methyl-2-methylindol-3-yl)-3-(2-hexyloxy-4-diethylaminophenyl)-4-azaphthalide, 3,3-bis(2-ethoxy-4-diethylaminophenyl)-4-azaphthalide, 3,3-bis(2-ethoxy-4-diethylaminophenyl)-7-azaphthalide, 2-(p-acetylanilino)-6-(N-n-amyl-N-n-butylamino)fluorane, 2-benzylamino-6-(N-ethyl-p-toluidino)fluorane, 2-benzylamino-6-(N-methyl-2,4-dimethylanilino)fluorane, 2-benzylamino-6-(N-ethyl-2,4-dimethylanilino)fluorane, 2-benzylamino-6-(N-methyl-p-toluidino)fluorane, 2-benzylamino-6-(N-ethyl-p-toluidino)fluorane, 2-(di-p-methylbenzylamino)-6-(N-ethyl-p-toluidino)fluorane, 2-(a-phenylethylamino)-6-(N-ethyl-p-toluidino)fluorane, 2-methylamino-6-(N-methylanilino)fluorane, 2-methylamino-6-(N-ethylanilino)fluorane, 2-methylamino-6-(N-propylanilino)fluorane, 2-ethylamino-6-(N-methyl-p-toluidino)fluorane, 2-methylamino-6-(N-methyl-2,4-dimethylanilino)fluorane, 2-ethylamino-6-(N-ethyl-2,4-dimethylanilino)fluorane, 2-dimethylamino-6-(N-methylanilino)fluorane, 2-dimethylamino-6-(N-ethylanilino)fluorane, 2-diethylamino-6-(N-methyl-p-toluidino)fluorane, 2-diethylamino-6-(N-ethyl-p-toluidino)fluorane, 2-dipropylamino-6-(N-methylanilino)fluorane, 2-dipropylamino-6-(N-ethylanilino)fluorane, 2-amino-6-(N-methylanilino)fluorane, 2-amino-6-(N-ethylanilino)fluorane, 2-amino-6-(N-propylanilino)fluorane, 2-amino-6-(N-methyl-p-toluidino)fluorane, 2-amino-6-(N-ethyl-p-toluidino)fluorane, 2-amino-6-(N-propyl-p-toluidino)fluorane, 2-amino-6-(N-methyl-p-ethylanilino)fluorane, 2-amino-6-(N-ethyl-p-ethylanilino)fluorane, 2-amino-6-(N-propyl-p-ethylanilino)fluorane, 2-amino-6-(N-methyl-2,4-dimethylanilino)fluorane, 2-amino-6-(N-ethyl-2,4-dimethylanilino)fluorane, 2-amino-6-(N-propyl-2,4-dimethylanilino)fluorane, 2-amino-6-(N-methyl-p-chloroanilino)fluorane, 2-amino-6-(N-ethyl-p-chloroanilino)fluorane, 2-amino-6-(N-propyl-p-chloroanilino)fluorane, 1,2-benzo-6-(N-ethyl-N-isoamylamino)fluorane, 1,2-benzo-6-dibutylaminofluorane, 1,2-benzo-6-(N-methyl-N-cyclohexylamino)fluorane, and 1,2-benzo-6-(N-ethyl-N-toluidino)fluorane. The recording layer 12 may contain one of the above leuco dyes alone or two or more of them.

### (Color Developer)

The color developer is capable of, for example, causing a colorless coloring compound to develop color. The color developer is a compound having a group with electron acceptability in the molecule. When the electron-accepting portion of the color developer reacts with a lactone ring of the coloring compound and the lactone ring opens, the coloring compound develops color.

The color developer includes a compound represented by the following formula (a).

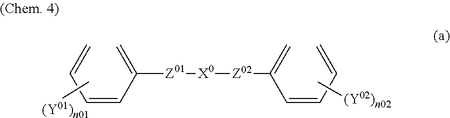

(wherein, in the formula (a), X⁰ represents a divalent group that has at least one benzene ring. Y⁰¹ and Y⁰² independently represent a monovalent group. n01 and n02 independently represent an integer from 0 to 5. When n01 represents an integer from 2 to 5, each Y⁰¹ may be the same or different. When n02 represents an integer from 2 to 5, Y⁰² may be the same or different. Z⁰¹ and Z⁰² independently represent a hydrogen-bonding group.)

When X⁰ includes at least one benzene ring, since the melting point can be made higher than that in the case where X⁰ represents an aliphatic hydrocarbon group (e.g., a normal alkyl chain), it is possible to improve color development retention characteristics during high-temperature and high-humidity preservation (hereinafter, referred to as “high-temperature and high-humidity preservation characteristics”.). From the viewpoint of improving high-temperature and high-humidity preservation characteristics and heat resistance, X⁰ favorably has at least two benzene rings. The high-temperature and high-humidity preservation characteristics are, for example, preservation characteristics in an environment of 80° C. and 60% RH. When the heat resistance is improved, the resistance of the recording medium 10 to harsh processes (e.g., hot pressing or integral molding using a molten resin) is improved. In the case where X⁰ has at least two benzene rings, the at least two benzene rings may be condensed. For example, naphthalene or anthracene may be obtained.

When Z⁰¹ and Z⁰² independently represent a hydrogen-bonding group, the color developers tend to solidify to some extent via hydrogen bonds. Thus, the stability of the color developer in the recording layer 12 is improved. In the present specification, the hydrogen-bonding group represents a functional group that contains an atom that can form a hydrogen bond with an atom in another functional group, another compound, or the like.

The color developer favorably includes a compound represented by the following formula (1).

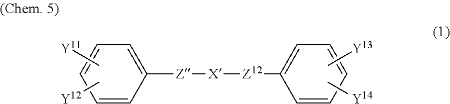

(wherein, in the formula (1), X¹ represents a divalent group that has at least one benzene ring. Y¹¹, Y¹², Y¹³, and Y¹⁴ independently represent a monovalent group. Z¹¹ and Z¹² independently represent a hydrogen-bonding group.)

When X¹ includes at least one benzene ring, since the melting point can be made higher than that in the case where X¹ represents an aliphatic hydrocarbon group (e.g., a normal alkyl chain), it is possible to improve high-temperature and high-humidity preservation characteristics. From the viewpoint of improving high-temperature and high-humidity preservation characteristics and heat resistance, X¹ favorably has at least two benzene rings. In the case where X¹ has at least two benzene rings, the at least two benzene rings may be condensed. For example, naphthalene or anthracene may be obtained.

When Z¹¹ and Z¹² independently represent a hydrogen-bonding group, the color developers tend to solidify to some extent via hydrogen bonds. Thus, the stability of the color developer in the recording layer 12 is improved.

In the case where the formula (a) and the formula (1) include a hydrocarbon group, the hydrocarbon group represents a general term for groups containing carbon (C) and hydrogen (H), and may be a saturated hydrocarbon group or an unsaturated hydrocarbon group. The saturated hydrocarbon group is an aliphatic hydrocarbon group having no carbon-carbon multiple bond, and the unsaturated hydrocarbon group is an aliphatic hydrocarbon group having a carbon-carbon multiple bond (a carbon-carbon double bond or a carbon-carbon triple bond).

In the case where the formula (a) and the formula (1) include a hydrocarbon group, the hydrocarbon group may be a chain one or include one or two or more rings. The chain may be linear or branched having one or two or more side chains or the like.

(X⁰ and X¹ Having One Benzene Ring)

X⁰ in the formula (a) and X¹ in the formula (1) represent, for example, a divalent group having one benzene ring. The divalent group is represented by, for example, the following formula (3).

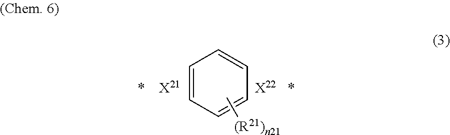

(wherein, in the formula (3), X²¹ does not necessarily need to be present and represents a divalent group when X²¹ is present. X²² does not necessarily need to be present and represents a divalent group when X²² is present. R²¹ represents a monovalent group. n21 represents an integer from 0 to 4. When n21 represents an integer from 2 to 4, each R²¹ may be the same or different. A mark * represents a bonding portion.)

In the formula (3), the bonding sites of X²¹ and X²² to a benzene ring are not limited. That is, the bonding sites of X²¹ and X²² to a benzene ring may be any of an ortho portion, a meta position, and a para position.

The above divalent group having one benzene ring is favorably represented by the following formula (4) from the viewpoint of improving high-temperature and high-humidity preservation characteristics.

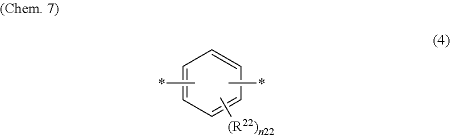

(wherein, in the formula (4), R²² represents a monovalent group. n22 represents an integer from 0 to 4. When n22 represents an integer from 2 to 4, each R²² may be the same or different. A mark * represents a bonding portion.

In the case where X⁰ in the formula (a) represents a divalent group having one benzene ring, the bonding sites of Z⁰¹ and Z⁰² to a benzene ring are not limited in the formula (4). That is, the bonding sites of Z⁰¹ and Z⁰² to a benzene ring may be any of an ortho portion, a meta position, and a para position.

In the case where X¹ in the formula (1) represents a divalent group having one benzene ring, the bonding sites of Z¹¹ and Z¹² to a benzene ring are not limited in the formula (4). That is, the bonding sites of Z¹¹ and Z¹² to a benzene ring may be any of an ortho portion, a meta position, and a para position.

(X²¹ and X²²)

X²¹ and X²² in the formula (3) only need to independently represent a divalent group and are not particularly limited. Examples thereof include a hydrocarbon group, which may have a substituent group. The hydrocarbon group is favorably a chain one. When the hydrocarbon group is a chain one, the melting point of the color developer can be reduced. Thus, the color developer melts by irradiation of laser light, making it easier for the coloring compound to develop color. From the viewpoint of reducing the melting point of the color developer, a normal alkyl chain, of the chain hydrocarbon groups, is particularly favorable.

The number of carbons in the hydrocarbon group, which may have a substituent group, is, for example, 1 or more and 15 or less, 1 or more and 13 or less, 1 or more and 12 or less, 1 or more and 10 or less, 1 or more and 6 or less, or 1 or more and 3 or less.

In the case where X²¹ and X²² in the formula (3) represent a normal alkyl group, the number of carbons in the normal alkyl group is favorably 8 or less, more favorably 6 or less, still more favorably 5 or less, and particularly favorably 3 or less from the viewpoint of the high-temperature preservation stability. When the number of carbons in the normal alkyl group is 8 or less, since the length of the normal alkyl group is short, it is considerable that thermal disturbances are less likely to occur in the color developer during high-temperature preservation and the sites that have interacted with the coloring compound such as a leuco dye during color development become difficult to remove. Therefore, since the coloring compound such as a leuco dye becomes difficult to lose its color during high-temperature preservation, the high-temperature preservation stability is improved.

Examples of the substituent group that the hydrocarbon group may have include a halogen group (e.g., a fluorine group) and an alkyl group having a halogen group (e.g., a fluorine group). In the hydrocarbon group, which may have a substituent group, some of the carbons in the hydrocarbon group (e.g., some of the carbons contained in the main chain of the hydrocarbon group) are substituted with an element such as oxygen.

### (R²¹)

R²¹ in the formula (3) only needs to represent a monovalent group and is not particularly limited. Examples thereof include a halogen group and a hydrocarbon group, which may have a substituent group.

The halogen group is, for example, a fluorine group (—F), a chlorine group (—Cl), a bromine group(—Br), or an iodine group (—I).

The carbons in the hydrocarbon group, which may have a substituent group, is for example, 1 or more and 15 or less, 1 or more and 13 or less, 1 or more and 12 or less, 1 or more and 10 or less, 1 or more and 6 or less, or 1 or more and 3 or less.

Examples of the substituent group that the hydrocarbon group may have include a halogen group (e.g., a fluorine group) and an alkyl group having a halogen group (e.g., a fluorine group). In the hydrocarbon group, which may have a substituent group, some of the carbons in the hydrocarbon group (e.g., some of the carbons contained in the main chain of the hydrocarbon group) are substituted with an element such as oxygen.

### (R²²)

R²² in the formula (4) only needs to represent a monovalent group, and is not particularly limited. Examples thereof include a halogen group and a hydrocarbon group, which may have a substituent group. The halogen group and the hydrocarbon group, which may have a substituent group, are similar to those in R²¹ in the above formula (3).

(X⁰ and X¹ Having Two Benzene Rings)

X⁰ in the formula (a) and X¹ in the formula (1) represent, for example, a divalent group having two benzene rings. The divalent group is represented by, for example, the following formula (5).

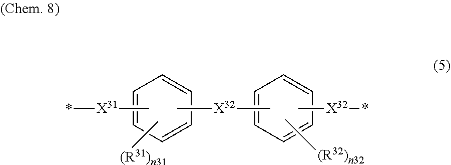

(wherein, in the formula (5), X³¹ does not necessarily need to be present and represents a divalent group when X³¹ is present. X³² does not necessarily need to be present and represents a divalent group when X³² is present. X³³ does not necessarily need to be present and represents a divalent group when X³³ is present. R³¹ and R³² independently represent a monovalent group. n31 and n32 independently represent an integer from 0 to 4. When n31 represents an integer from 2 to 4, R³¹ may be the same or different. When n32 represents an integer from 2 to 4, R³² may be the same or different. A mark * represents a bonding portion.)

In the formula (5), the bonding sites of X³¹ and X³² to a benzene ring are not limited. That is, the bonding sites of X³¹ and X³² to a benzene ring may be any of an ortho portion, a meta position, and a para position. Similarly, in the formula (5), the bonding sites of X³² and X³³ to a benzene ring are not limited. That is, the bonding sites of X³² and X³³ to a benzene ring may be any of an ortho portion, a meta position, and a para position.

The above divalent group having two benzene rings is favorably represented by the following formula (6) from the viewpoint of improving high-temperature and high-humidity preservation characteristics.

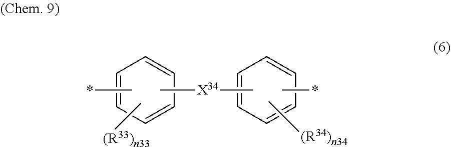

(wherein, in the formula (6), X³⁴ represents a divalent group. R³³ and R³⁴ independently represent a monovalent group. n33 and n34 independently represent an integer from 0 to 4. When n33 represents an integer from 2 to 4, R³³ may be the same or different. When n34 represents an integer from 2 to 4, R³⁴ may be the same or different. A mark * represents a bonding portion.)

X⁰ in the formula (a) represents a divalent group having two benzene rings, the bonding sites of Z⁰¹ and X³⁴ to a benzene ring are not limited in the formula (6). That is, the bonding sites of Z⁰¹ and X³⁴ to a benzene ring may be any of an ortho portion, a meta position, and a para position. Similarly, in the formula (6), the bonding sites of Z⁰² and X³⁴ to a benzene ring are not limited. That is, the bonding sites of Z⁰² and X³⁴ to a benzene ring may be any of an ortho portion, a meta position, and a para position.

In the case where X¹ in the formula (1) represents a divalent group having two benzene rings, the bonding sites of Z¹¹ and X³⁴ to a benzene ring are not limited in the formula (6). That is, the bonding sites of Z¹¹ and X³⁴ to a benzene ring may be any of an ortho portion, a meta position, and a para position. Similarly, in the formula (6), the bonding sites of Z¹² and X³⁴ to a benzene ring are not limited. That is, the bonding sites of Z¹² and X³⁴ to a benzene ring may be any of an ortho portion, a meta position, and a para position.

(X³¹, X³², and X³³)

X³¹, X³², and X³³ in the formula (5) only need to independently represent a divalent group and are not particularly limited. Examples thereof include a hydrocarbon group, which may have a substituent group. The hydrocarbon group is similar to that in X²¹ and X²² in the above formula (3).

### (X³⁴)

X³⁴ in the formula (6) only needs to represent a divalent group and is not particularly limited. Examples thereof include a hydrocarbon group, which may have a substituent group. The hydrocarbon group is similar to that in X²¹ and X²² in the above formula (3).

(R³¹ and R³²)

R³¹ and R³² in the formula (5) only need to represent a monovalent group, and are not particularly limited. Examples thereof include a halogen group and a hydrocarbon group, which may have a substituent group. The halogen group and the hydrocarbon group, which may have a substituent group, are similar to those in R²¹ in the above formula (3).

(R³³ and R³⁴)

R³³ and R³⁴ in the formula (6) only need to represent a monovalent group, and are not particularly limited. Examples thereof include a halogen group and a hydrocarbon group, which may have a substituent group. The halogen group and the hydrocarbon group, which may have a substituent group, are similar to those in R²¹ in the above formula (3).

(Y⁰¹ and Y⁰²)

Y⁰¹ and Y⁰² in the formula (a) independently represent, for example, a hydrogen group (—H), a hydroxy group (—OH), a halogen group (—X), a carboxy group (—COOH), an ester group (—COOR), or a hydrocarbon group, which may have a substituent group.

The halogen group is, for example, a fluorine group (—F), a chlorine group (—Cl), a bromine group (—Br), or an iodine group (—I).

The number of carbons in the hydrocarbon group, which may have a substituent group, is, for example, 1 or more and 15 or less, 1 or more and 13 or less, 1 or more and 12 or less, 1 or more and 10 or less, 1 or more and 6 or less, or 1 or more and 3 or less.

Examples of the substituent group that the hydrocarbon group may have include a halogen group (e.g., a fluorine group) and an alkyl group having a halogen group (e.g., a fluorine group). In the hydrocarbon group, which may have a substituent group, some of the carbons in the hydrocarbon group (e.g., some of the carbons contained in the main chain of the hydrocarbon group) are substituted with an element such as oxygen.

In the formula (a), one of (Y⁰¹)ₙ₀₁ and/or one of (Y⁰²)ₙ₀₂ favorably represents a hydroxy group (—OH). When one of (Y⁰¹)ₙ₀₁ and/or one of (Y⁰²)ₙ₀₂ represents a hydroxy group (—OH), it is possible to improve display quality and light resistance.

(Y¹¹, Y¹², Y¹³, and Y¹⁴)

In the formula (1), the bonding sites of Y¹¹ and Y¹² to a benzene ring are not limited. That is, the bonding sites of Y¹¹ and Y¹² to a benzene ring may be any of an ortho portion, a meta position, and a para position. Similarly, in the formula (1), the bonding sites of Y¹³ and Y¹⁴ to a benzene ring are also not limited. That is, the bonding sites of Y¹³ and Y¹⁴ to a benzene ring may also be any of an ortho portion, a meta position, and a para position. In the formula (1), the bonding sites of Y¹¹ and Y¹² to one benzene and the bonding sites of Y¹³ and Y¹⁴ to the other benzene may be the same or different.

Y¹¹, Y¹², Y¹³, and Y¹⁴ in the formula (1) independently represent, for example, a hydrogen group (—H), a hydroxy group (—OH), a halogen group, a carboxy group (—COOH), an ester group (—COOR), or a hydrocarbon group, which may have a substituent group. The halogen group and the hydrocarbon group, which may have a substituent group, are similar to those in Y⁰¹ and Y⁰² in the above formula (a).

In the formula (1), Y¹¹ and/or Y¹³ favorably represents a hydroxy group (—OH). When Y¹¹ and/or Y¹³ represents a hydroxy group (—OH), it is possible to improve display quality and light resistance.

(Z⁰¹ and Z⁰²)

Z⁰¹ and Z⁰² in the formula (1) independently represent, for example, a urea bond (—NHCONH—), an amide bond (—NHCO—, —OCHN—), or a hydrazide bond (—NHCOCONH—). From the viewpoint of improving high-temperature and high-humidity preservation characteristics, Z⁰¹ and Z⁰² favorably represent a urea bond. In the case where Z⁰¹ represents an amide bond, nitrogen contained in the amide bond may be bonded to benzene or carbon contained in the amide bond may be bonded to benzene. In the case where Z⁰² represents an amide bond, nitrogen contained in the amide bond may be bonded to benzene or carbon contained in the amide bond may be bonded to benzene.

(Z¹¹ and Z¹²)

Z¹¹ and Z¹² in the formula (1) independently represent, for example, a urea bond (—NHCONH—), an amide bond (—NHCO—, —OCHN—), or a hydrazide bond (—NHCOCONH—). From the viewpoint of improving high-temperature and high-humidity preservation characteristics, Z¹¹ and Z¹² favorably represent a urea bond. In the case where Z¹¹ represents an amide bond, nitrogen contained in the amide bond may be bonded to benzene or carbon contained in the amide bond may be bonded to benzene. In the case where Z¹² represents an amide bond, nitrogen contained in the amide bond may be bonded to benzene or carbon contained in the amide bond may be bonded to benzene.

(Specific Example of Color Developer) A color developer in which X⁰ in the formula (a) and X¹ in the formula (1) have one benzene ring specifically includes at least one selected from the group consisting of, for example, compounds represented by the following formulae (3-1) to (3-6).

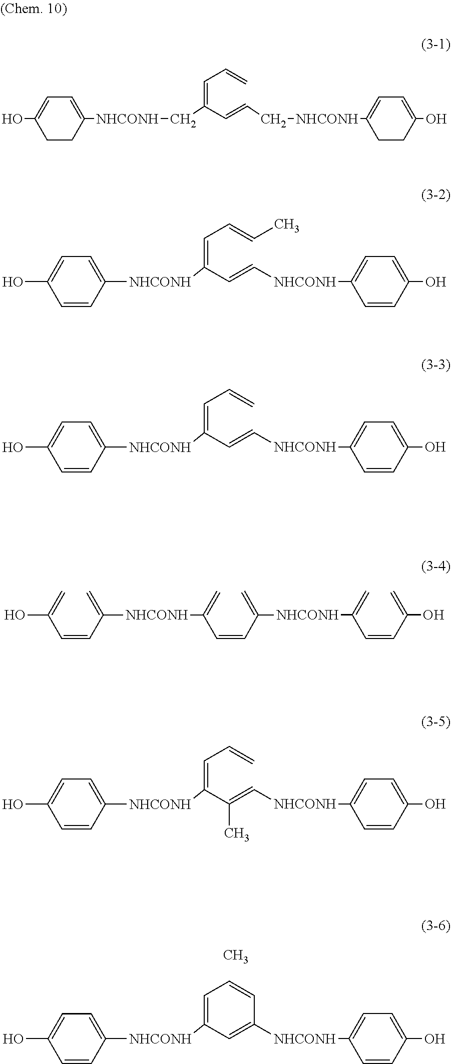

A color developer in which X⁰ in the formula (a) and X¹ in the formula (1) have two benzene rings specifically includes at least one selected from the group consisting of, for example, compounds represented by the following formulae (5-1) to (5-8).

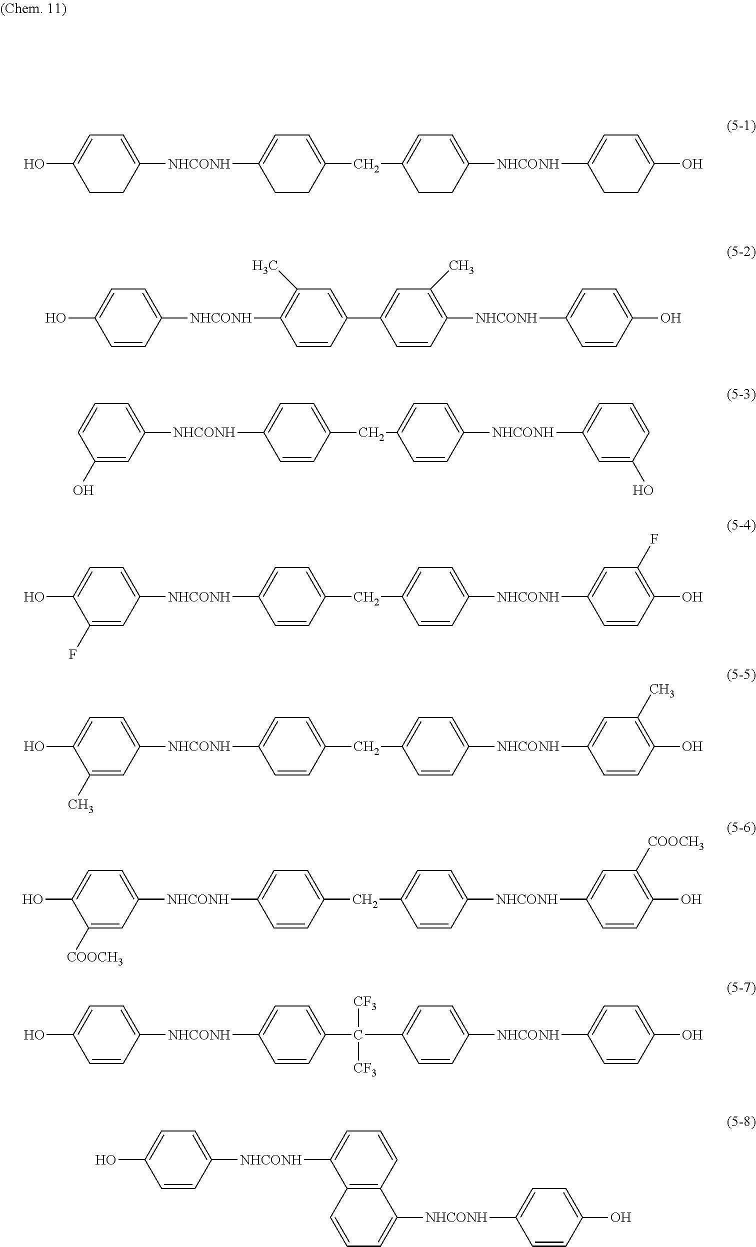

### (Photothermal Conversion Agent)

The photothermal conversion agent is capable of absorbing light in a predetermined wavelength range such as a near-infrared region to generate heat. As the photothermal conversion agent, for example, it is favorable to use a near-infrared absorbing dye that has an absorption peak in the wavelength range of 700 nm or more and 2000 nm or less and has substantially no absorption in the visible region. Specific examples thereof include at least one selected from the group consisting of a compound having a phthalocyanine skeleton (phthalocyanine dye), a compound having a squarylium skeleton (squarylium dye), and an inorganic compound.

Examples of the inorganic compound include at least one selected from the group consisting of a metal complex such as a dithio complex, a diimonium salt, an aminium salt, graphite, carbon black, metal powder particles, tricobalt tetroxide, iron oxide, chromium oxide, copper oxide, titanium black, a metal oxide such as ITO (Indium Tin Oxide), a metal nitride such as niobium nitride, a metal carbide such as tantalum carbide, a metal sulfide, and various magnetic powders. In addition, a compound having a cyanine skeleton, which has excellent light resistance and heat resistance, (cyanine dye) may be used. Note that here, the excellent light resistance means that it is not decomposed under the environment of use by irradiation of light such as light from a fluorescent light. The excellent heat resistance means that, for example, the maximum absorption peak value of the absorption spectrum does not change by 20% or more when it is deposited with a polymer material and preserved at 150° C. for 30 minutes, for example. Examples of such a compound having a cyanine skeleton include those having at least one of a counter ion of any of SbF₆, PF₆, BF₄, ClO₄, CF₃SO₃, and (CF₃SO₃)₂N and a methine chain having a 5-membered ring or a 6-membered ring in the molecule. Note that in the first embodiment, although the compound having a cyanine skeleton used for the recording medium 10 favorably has both any of the above counter ions and a cyclic structure such as a 5-membered ring and a 6-membered ring in a methine chain, sufficient light resistance and heat resistance are ensured when the compound has at least one of them.

### (Matrix Resin)

The matrix resin favorably has a function as a binder. The matrix resin is favorably one in which the coloring compound, the color developer, and the photothermal conversion agent are easily and homogenously dispersed. The matrix resin includes, for example, at least one selected from the group consisting of a thermosetting resin and a thermoplastic resin. The matrix resin favorably includes a polycarbonate resin. When the matrix resin includes a polycarbonate resin, it is possible to improve light resistance of the background of the recording medium 10. Here, the polycarbonate resin is a resin having, as a structural unit, a carbonate group (—O—(C═O)—O—) at least in the main chain. Therefore, the main chain may have another structural unit in addition to the carbonate group.

The matrix resin may include, instead of or in addition to the polycarbonate resin, at least one selected from the group consisting of polyvinyl chloride, polyvinyl acetate, a vinyl chloride-vinyl acetate copolymer, ethylcellulose, polystyrene, a styrene copolymer, a phenoxy resin, a polyester, an aromatic polyester, polyurethane, polyacrylic acid ester, polymethacrylic acid ester, an acrylic acid copolymer, a maleic acid polymer, polyvinylalcohol, modified polyvinylalcohol, hydroxyethyl cellulose, carboxymethyl cellulose, and starch.

### (Additive)

The recording layer 12 may further at least one additive selected from the group consisting of an antioxidant, a sensitizer, an ultraviolet absorber, a light stabilizer, and a hydrolysis inhibitor, as necessary. From the viewpoint of suppressing coloration of a background, the recording layer 12 favorably includes an amine compound.

In the case where the recording layer 12 includes an amine compound, the recording layer 12 favorably includes at least one compound selected from the group consisting of an epoxy compound and a carbodiimide compound, in addition to the amine compound. Although there is a possibility that the reliability of the colored portion during high-temperature and high-humidity preservation decreases when the recording layer 12 includes an amine compound, the decrease in reliability of the colored portion during high-temperature and high-humidity preservation due to the amine compound can be suppressed when the recording layer 12 includes at least one compound selected from the group consisting of an epoxy compound and a carbodiimide compound, in addition to the amine compound.

(Protective layer)

The protective layer 13 is for protecting the front surface of the recording layer 12. The protective layer 13 may have any of a single-layer structure and a multilayer structure. The protective layer 13 having a single-layer structure may be a coat layer such as a hard coat layer. The coat layer includes, for example, at least one cured product selected from the group consisting of a UV curable resin and a thermosetting resin. The coat layer may include fine particles, or the like. The protective layer having a multilayer structure may include a resin layer and a bonding layer provided on one surface of the resin layer. Note that the configuration of the thermal insulation layer having a multilayer structure is not limited to the above configuration. Further, the number of layers in the multilayer structure is not limited to the above two layers, and a structure having three or more layers may be adopted. The resin layer may be a polymer film or a coat layer such as a UV curable resin layer. The bonding layer is, for example, an adhesion layer or an adhesive layer. The thickness of the protective layer 13 is, for example, 0.1 μm or more and 20 μm or less.

### [1.2 Recording Method of Recording Medium]

An example of a recording method of a recording medium according to the first embodiment will be described below.

For example, when laser light is applied to a predetermined position of the recording layer 12 by a semiconductor laser, the photothermal conversion agent contained in the laser light irradiated portion of the recording layer 12 absorbs light and generates heat. The color developer melts due to this heat generation, and a coloring reaction (color development reaction) occurs between the color developer and the coloring compound. Specifically, the color developer melts, the color developer reacts with a lactone ring of the coloring compound (e.g., a leuco dye), the lactone ring opens, and thus, the coloring compound develops color. As a result, the laser light irradiated portion develops color and a desired image is drawn on the recording layer 12. As the laser light, it is favorable to use near-infrared laser light.

### [1.3 Method of Producing Recording Medium]

An example of the method of producing the recording medium 10 according to the first embodiment will be described below. Here, an example of producing the recording medium 10 using an application method will be described.

First, a matrix resin is dissolved in a solvent (e.g., methyl ethyl ketone). Next, a coloring compound in a decolored state, a color developer, and a photothermal conversion agent are added to this solution and dispersed. As a result, a paint for forming a recording layer is obtained. Subsequently, this paint for forming a recording layer is applied onto the base material 11 and dried to form the recording layer 12. Next, the base material 11 and the recording layer 12 may be integrated by heat pressing as necessary. Next, a paint for forming a protective layer is applied onto the recording layer 12 and cured as necessary. The paint for forming a protective layer includes, for example, at least one selected from the group consisting of a UV curable resin and a thermosetting resin. In this way, the recording medium 10 shown in FIG. 1 is obtained.

### [1.4 Operation and Effect]

In the recording medium 10 according to the first embodiment, the color developer includes the compound represented by the above formula (a). Once the compound represented by the above formula (a) reacts with the coloring compound, it is difficult to separate. Further, since the color developers tend to solidify to some extent via hydrogen bonds, the stability of the color developer in the recording layer 12 is improved. Therefore, it is possible to improve high-temperature and high-humidity preservation characteristics of the recording medium 10.

Further, since the compound represented by the above formula (a) does not easily interact with the coloring compound, it is possible to suppress color development of a background. The reasons why the compound represented by the above formula (a) does not easily interact with the coloring compound are presumably because the melting point of the above compound is high, and due to steric hinderance or the like due to high aggregation ability between the above compounds, the type of terminal functional group of the above compound, and arrangement of functional groups of the above compound.

Further, when the color developer includes the compound represented by the above formula (a), since the energy required to cause the color developer in the recording layer 12 to melt increases, the recording medium 10 is capable of withstanding high-temperature pressing (e.g., high-temperature pressing at 150° C.). Here, “capable of withstanding” means that the color change due to high-temperature pressing can be suppressed.

In the case where X⁰ in the formula (a) represents a divalent group that has at least one benzene ring and Z¹¹ and Z¹² in the formula (1) represent a urea bond (—NHCONH—), since the melting point of the entire color developer can be made higher, it is possible to improve heat resistance of the recording medium 10. Therefore, it is possible to improve the resistance of the recording medium 10 to harsh processes (e.g., hot pressing or integral molding using a molten resin). Therefore, the recording medium 10 can be included in various products(an identity card, a card, an accessory (including a wearable terminal), an electronic apparatus, and the like).

In the case where the recording layer 12 includes a polycarbonate resin as a matrix resin (matrix polymer), the matrix resin is less likely to generate acid due to photolysis, and thus, it is possible to prevent the generated acid from reacting with the coloring compound. Therefore, it is possible to suppress the color development of the background (unrecorded area) of the recording medium 10. Therefore, it is possible to improve the light resistance of the background of the recording medium 10.

The matrix resin of the recording layer 12 includes a transparent polycarbonate resin. Since the polycarbonate resin itself has excellent transparency as well as the compounds represented by the above formula (a) and the above formula (1) have a benzene ring or the like in addition to a hydrogen bonding group in the molecule, the compatibility with the matrix resin is high. For this reason, it is easy to make the particle size small (e.g., 1 μm or less) during dispersion, and it is difficult to visually recognize during deposition. Therefore, it is improve the transparency of the recording layer 12.

### 2 Second Embodiment

Although an example in which a recording medium includes one recording layer has been described in the above first embodiment, an example in which a recording medium includes three recording layers having different color development hues in the colored state will be described in a second embodiment.

### [2.1 Configuration of Recording Medium]

An example of a configuration of a recording medium 10A according to the second embodiment will be described below with reference to FIG. 2. The recording medium 10A includes the base material 11, three recording layers 12A, 12B, and 12C, and two intermediate layers 14A and 14B. The three recording layers 12A, 12B, and 12C and the two intermediate layers 14A and 14B are stacked on the base material 11 in the order of the recording layer 12A, the intermediate layer 14A, the recording layer 12B, the intermediate layer 14B, and the recording layer 12C. The recording medium 10A may further include the protective layer 13 on the recording layer 12C.

### (Recording Layer)

The recording layers 12A, 12B, and 12C in the unrecorded state (initial state) are in the decolored state. The state of each of the recording layers 12A, 12B, and 12C can be changed from the decolored state to the colored state by irradiation of laser light. The recording layers 12A, 12B, and 12C are capable of exhibiting different hues in the colored state. Specifically, the recording layer 12A is capable of exhibiting a magenta color in the colored state. The recording layer 12B is capable of exhibiting a cyan color in the colored state. The recording layer 12C is capable of exhibiting a yellow color in the colored state. The magenta color, the cyan color, and the yellow color are respectively examples of a first color, a second color, and a third color. The first color, the second color, and the third color may be colors other than the magenta color, the cyan color, and the yellow color. The laser light capable of changing the state of the recording layer 12A to the colored state, the laser light capable of changing the state of the recording layer 12B to the colored state, and the laser light capable of changing the state of the recording layer 12C to the colored state have different peak wavelengths.

The thickness of each of the recording layers 12A, 12B, and 12C is favorably 1 μm or more and 20 μm or less, more favorably 2 μm or more and 15 μm or less. When the thickness of each of the recording layers 12A, 12B, and 12C is 1 μm or more, it is possible to improve the color density. Meanwhile, the thickness of each of the recording layers 12A, 12B, and 12C is 20 μm or less, it is possible to suppress the increase in heat utilization amount of the recording layers 12A, 12B, and 12C and suppress deterioration of the color development.

The recording layer 12A includes a first coloring compound with electron-donating properties, a first color developer with electron acceptability, and a first photothermal conversion agent. The recording layer 12A favorably further includes a first matrix resin.

The recording layer 12B includes a second coloring compound with electron-donating properties, a second color developer with electron acceptability, and a second photothermal conversion agent. The recording layer 12B favorably further includes a second matrix resin.

The recording layer 12C includes a third coloring compound with electron-donating properties, a third color developer with electron acceptability, and a third photothermal conversion agent. The recording layer 12C favorably further includes a third matrix resin.

### (First, Second, and Third Coloring Compounds)

The first, second, and third coloring compounds are capable of exhibiting different hues in the colored state. Specifically, the first coloring compound is capable of exhibiting a magenta color in the colored state. The second coloring compound is capable of exhibiting a cyan color in the colored state. The third coloring compound is capable of exhibiting a yellow color in the colored state. The magenta color, the cyan color, and the yellow color are respectively examples of the first color, the second color, and the third color. The first color, the second color, and the third color may be colors other than the magenta color, the cyan color, and the yellow color.

### (First, Second, and Third Color Developers)

The first color developer is for causing the first coloring compound in the decolored state to develop color. The second color developer is for causing the second coloring compound in the decolored state to develop color. The third color developer is for causing the third coloring compound in the decolored state to develop color. As the first, second, and third color developers, those similar to the color developer included in the recording layer 12 according to the first embodiment can be used. The types of first, second, and third color developers may be the same, or the types of first, second, and third color developers may be different from each other.

### (First, Second, and Third Photothermal Conversion Agents)

The first, second, and third photothermal conversion agents absorb light in a predetermined wavelength range such as a near-infrared region, and generate heat. The first, second, and third photothermal conversion agents have different absorption wavelength peaks. Specifically, the first photothermal conversion agent has an absorption wavelength peak at a wavelength λ₁. The second photothermal conversion agent has an absorption wavelength peak at a wavelength λ₂. The third photothermal conversion agent has an absorption wavelength peak at a wavelength λ₃. The wavelengths λ₁, λ₂, and λ₃ are different from each other. The absorption wavelength peak is favorably in a near-infrared region. The near-infrared region is, for example, a wavelength range of 700 nm or more and 2000 nm or less. Since the first, second, and third photothermal conversion agents have different absorption wavelength peaks as described above, it is possible to selectively causing a desired layer of the recording layers 12A, 12B, and 12C to develop color by irradiation of laser light. Examples of the first, second, and third photothermal conversion agents include those similar to the photothermal conversion agent included in the recording layer 12 according to the first embodiment.

### (First, Second, and Third Matrix Resins)

Examples of the first, second, and third matrix resins include those similar to the matrix resin included in the recording layer 12 according to the first embodiment. The types of first, second, and third matrix resins may be the same, or the types of first, second, and third matrix resins may be different from each other.

### (Additive)

The recording layers 12A, 12B, and 12C may include an additive similar to that in the above recording layer 12 as necessary.

(Intermediate layer)

The intermediate layer 14A is provided between the recording layer 12A and the recording layer 12B. The intermediate layer 14A is a thermal insulation layer capable of providing heat insulation between the recording layer 12A and the recording layer 12B. The intermediate layer 14B is provided between the recording layer 12B and the recording layer 12C. The intermediate layer 14B is a thermal insulation layer capable of providing heat insulation between the recording layer 12B and the recording layer 12C.

The intermediate layers 14A and 14B are each formed of, for example, a general polymer material having transparency. Specific examples of the material include at least one selected from the group consisting of polyvinyl chloride, polyvinyl acetate, a vinyl chloride-vinyl acetate copolymer, ethylcellulose, polystyrene, a styrene copolymer, a phenoxy resin, a polyester, an aromatic polyester, polyurethane, polycarbonate, polyacrylic acid ester, polymethacrylic acid ester, an acrylic acid copolymer, a maleic acid polymer, polyvinylalcohol, modified polyvinylalcohol, hydroxyethyl cellulose, carboxymethyl cellulose, a silicone, polyethylene, polypropylene, and starch. Note that the intermediate layers 14A and 14B may each include, for example, various additives such as an ultraviolet absorber.

Further, the intermediate layers 14A and 14B may each be formed of an inorganic material having transparency. For example, it is favorable to use porous silica, alumina, titania, carbon, or a composite thereof, because the thermal conductivity is low and the heat insulation effect is high. The intermediate layers 14A and 14B can be formed of, for example, a sol-gel method.

The thickness of each of the intermediate layers 14A and 14B is favorably 3 μm or more and 100 μm or less, more favorably 5 μm or more and 50 μm or less. When the thickness of each of the intermediate layers 14A and 14B is too small, there is a possibility that a sufficient heat insulation effect cannot be achieved. Meanwhile, when the thickness of each of the intermediate layers 14A and 14B is too large, there is a possibility that the transparency decreases. Further, there is also a possibility that the bending resistance of the recording medium 10B decreases and defects such as cracking easily occur.

### [2.2 Recording Method of Recording Medium]

An example of a recording method of the recording medium 10A according to the second embodiment will be described.

The recording layer 12A develops a magenta color as follows. When a predetermined position of the recording layer 12A is irradiated with near-infrared laser light having the peak wavelength λ₁, the first photothermal conversion agent contained in the laser light irradiated portion absorbs the near-infrared laser light and generates heat. The first color developer melts due to this heat generation, a coloring reaction (color development reaction) occurs between the first color developer and the first coloring compound, and the laser light irradiated portion develops a magenta color.

The recording layer 12B develops a cyan color as follows. When a predetermined position of the recording layer 12B is irradiated with near-infrared laser light having the peak wavelength λ₂, the laser light irradiated portion develops a cyan color by a reaction similar to that of the above recording layer 12A.

The recording layer 12C develops a yellow color as follows. When a predetermined position of the recording layer 12B is irradiated with near-infrared laser light having the peak wavelength λ₃, the laser light irradiated portion develops a yellow color by a reaction similar to that of the above recording layer 12A.

When the predetermined positions of the recording layers 12A, 12B, and 12C respectively develop a magenta color, a cyan color, and a yellow color as described above, a desired full-color image is drawn on the recording medium 10A.

### [2.3 Operation and Effect]

In the recording medium 10A according to the second embodiment, it is possible to achieve the operation and effect similar to those in the recording medium 10 according to the first embodiment.

Further, in the recording medium 10A according to the second embodiment, the recording layers 12A, 12B, and 12C are capable of respectively exhibiting a magenta color, a cyan color, and a yellow color in the colored state. Therefore, it is possible to draw a desired image in full color.

### 3 Third Embodiment

Although an example in which a recording medium includes three recording layers and a full-color image can be drawn has been described in the above second embodiment, an example in which a recording medium includes a recording layer including three types of microcapsules and a full-color image can be drawn will be described in a third embodiment.

### [3.1 Configuration of Recording Medium]

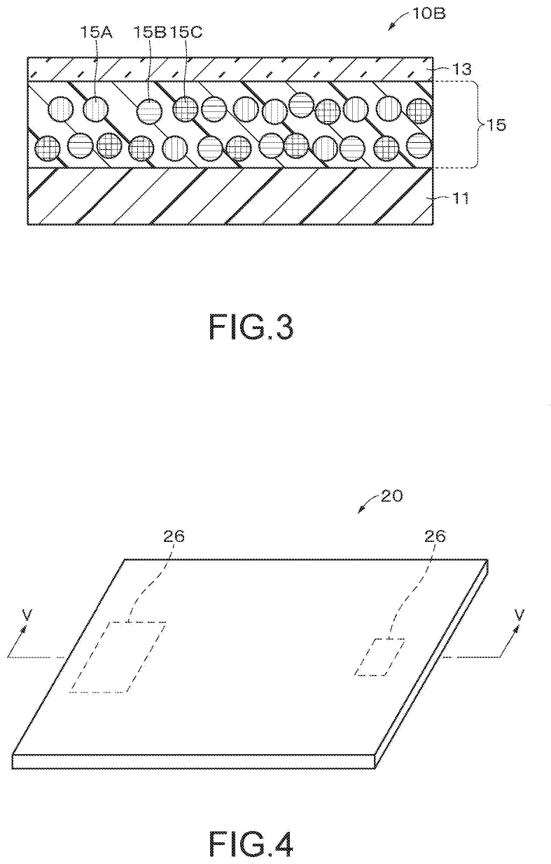

An example of a configuration of a recording medium 10B according to a third embodiment will be described below with reference to FIG. 3. The recording medium 10B includes the base material 11 and a recording layer 15 provided on the base material 11. The recording medium 10B may further include the protective layer 13 provided on the recording layer 15. Note that in the third embodiment, portions similar to those in the first embodiment will be denoted by the same reference symbols and description thereof will be omitted.

### (Recording Layer)

The recording layer 15 includes three types of microcapsules 15A, 15B, and 15C and a matrix resin. The coloring state of each of the microcapsules 15A, 15B, and 15C can be changed by irradiation of laser light. The microcapsules 15A, 15B, and 15C are capable of exhibiting different hues in the colored state. Specifically, the microcapsule 15A is capable of exhibiting a magenta color in the colored state. The microcapsule 15B is capable of exhibiting a cyan color in the colored state. The microcapsule 15C is capable of exhibiting a yellow color in the colored state. The magenta color, the cyan color, and the yellow color are respectively examples of the first color, the second color, and the third color. The first color, the second color, and the third color may be colors other than the magenta color, the cyan color, and the yellow color. The laser light capable of changing the state of the microcapsule 15A to the colored state, the laser light capable of changing the state of the microcapsule 15B to the colored state, and the laser light capable of changing the state of the microcapsule 15C to the colored state have different peak wavelengths.

The microcapsule 15A includes a first microcapsule wall, a first coloring compound with electron-donating properties, a first color developer with electron acceptability, and a first photothermal conversion agent. The microcapsule 15A may further include a first matrix resin. The first microcapsule wall encapsulates the above various materials.

The microcapsule 15B includes a second microcapsule wall, a second coloring compound with electron-donating properties, a second color developer with electron acceptability, and a second photothermal conversion agent. The microcapsule 15B may further include a second matrix resin. The second microcapsule wall encapsulates the above various materials.

The microcapsule 15C includes a third microcapsule wall, a third coloring compound with electron-donating properties, a third color developer with electron acceptability, and a third photothermal conversion agent. The microcapsule 15C may further include a third matrix resin. The third microcapsule wall encapsulates the above various materials.

### (Microcapsule Wall)

The first, second, and third microcapsule walls are each formed of, for example, a polymer material having transparency. Specific examples of the material of the microcapsule wall include at least one selected from the group consisting of polyvinyl chloride, polyvinyl acetate, a vinyl chloride-vinyl acetate copolymer, ethylcellulose, polystyrene, a styrene copolymer, a phenoxy resin, a polyester, an aromatic polyester, polyurethane, polycarbonate, polyacrylic acid ester, polymethacrylic acid ester, an acrylic acid copolymer, a maleic acid polymer, polyvinylalcohol, modified polyvinylalcohol, hydroxyethyl cellulose, carboxymethyl cellulose, and starch. The materials of the first, second, and third microcapsule walls may be the same, or the materials of the first, second, and third microcapsule walls may be different from each other.

(First, Second, and Third Dyes with Electron-Donating Properties)

The first, second, and third dyes with electron-donating properties are similar to those in the second embodiment.

### (First, Second, and Third Color Developers)

The first, second, and third color developers are similar to those in the second embodiment.

### (First, Second, and Third Photothermal Conversion Agents)

The first, second, and third photothermal conversion agents are similar to those in the second embodiment.

### (First, Second, and Third Matrix Resins)

The first, second, and third matrix resins are similar to those in the second embodiment.

### (Additive)

The microcapsules 15A, 15B, and 15C may include an additive similar to that in the above recording layer 12 as necessary. In this case, the additive may be encapsulated in the first, second, and third microcapsule walls.

### [3.2 Recording Method of Recording Medium]

An example of the recording method of the recording medium 10B according to the third embodiment will be described below.

The recording layer 15 develops a magenta color as follows. A predetermined position of the recording layer 15 is irradiated with near-infrared laser light having the peak wavelength λ₁. The microcapsule 15A contained in the laser light irradiated portion develops a magenta color. As a result, the laser light irradiated portion develops a magenta color.

The recording layer 15 develops a cyan color as follows. A predetermined position of the recording layer 15 is irradiated with near-infrared laser light having the peak wavelength λ₂. The microcapsule 15B contained in the laser light irradiated portion develops a cyan color. As a result, the laser light irradiated portion develops a cyan color.

The recording layer 15 develops a yellow color as follows. A predetermined position of the recording layer 15 is irradiated with near-infrared laser light having the peak wavelength λ₃. The microcapsule 15C contained in the laser light irradiated portion develops a yellow color. As a result, the laser light irradiated portion develops a yellow color.

When the predetermined positions of the recording layer 15 develop a magenta color, a cyan color, and a yellow color as described above, a desired full-color image is drawn on the recording medium 10B.

### [3.3 Operation and Effect]

In the recording medium 10B according to the third embodiment, it is possible to achieve the operation and effect similar to those in the recording medium 10 according to the first embodiment.

Further, in the recording medium 10B according to the third embodiment, the recording layer 15 includes three types of microcapsules 15A, 15B, and 15C. The microcapsules 15A, 15B, and 15C are capable of respectively exhibiting a magenta color, a cyan color, and a yellow color in the colored state. Therefore, it is possible to draw a desired image in full color.

### 4 Fourth Embodiment

In a fourth embodiment, an example of a stacked body that includes the recording medium 10 according to the first embodiment, the recording medium 10A according to the second embodiment, or the recording medium 10B according to the third embodiment will be described.

### [4.1 Configuration of Stacked Body]

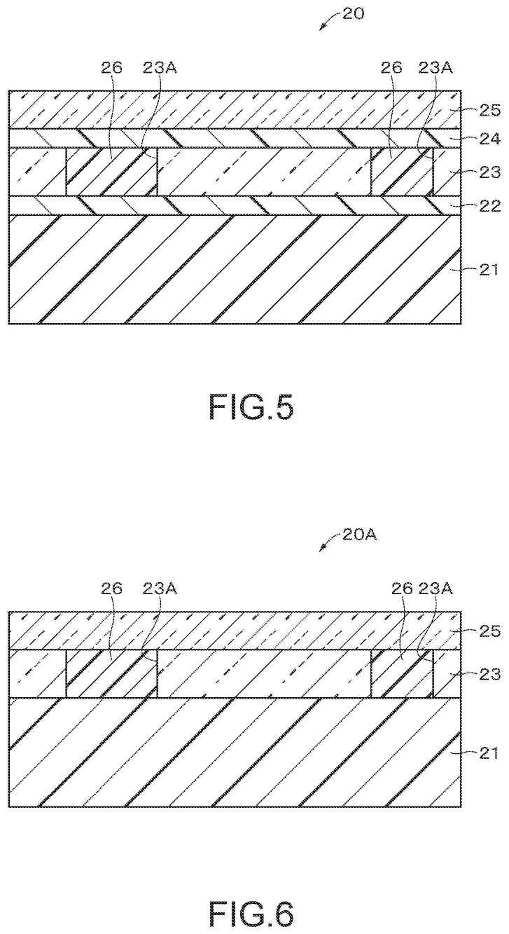

FIG. 4 is a perspective view showing an example of a configuration of a stacked body 20 according to the fourth embodiment. FIG. 5 is a cross-sectional view taken along the line V-V in FIG. 4. The stacked body 20 includes a base material 21, an adhesive layer 22, an intermediate layer 23, an adhesive layer 24, an overlay layer 25, and a recording medium 26. The stacked body 20 may be a card such as a security card, a financial payment card (e.g., a credit card or a cash card), an ID card (e.g., an employee ID card, a membership card, or a student ID card), and a personal transaction card (e.g., a prepaid card or a rewards card) (hereinafter, referred to as a “security card or the like”.).

### (Base Material)

The base material 21 is a support that supports the recording medium 26 and the intermediate layer 23. The base material 21 may be a card. The base material 21 may have a color such as white. A design, a picture, a photograph, a character, or a combination of two or more of them (hereinafter, referred to as a “design or the like”.) may be printed on one main surface of the base material 21 where the intermediate layer 23, the recording medium 26, and the like are provided.

The base material 21 includes, for example, plastic. The base material 21 may include, as necessary, at least one selected from the group consisting of a coloring agent, an antistatic agent, a flame retardant, and a surface modifier.

The plastic includes, for example, at least one selected from the group consisting of an ester resin, an amide resin, an olefin resin, a vinyl resin, an acrylic resin, an imide resin, a styrene resin, and engineering plastic. In the case where the base material 21 includes two or more types of resins, the two or more types of resins may be mixed, copolymerized, or stacked.

The ester resin includes, for example, at least one selected from the group consisting of polyethylene terephthalate (PET), polybutylene terephthalate (PBT), polyethylene naphthalate (PEN), a polyethylene terephthalate-isophthalate copolymer, and a terephthalic acid-cyclohexanedimethanol-ethylene glycol copolymer. The amide resin includes, for example, at least one selected from the group consisting of nylon 6, nylon 66, and nylon 610. The olefin resin includes, for example, at least one selected from the group consisting of polyethylene (PE), polypropylene (PP), and polymethylpentene (PMP). The vinyl resin includes, for example, polyvinyl chloride (PVC).

The acrylic resin includes, for example, at least one selected from the group consisting of polyacrylate, polymethacrylate, and polymethylmethacrylate (PMMA). The imide resin includes, for example, at least one selected from the group consisting of polyimide (PI), polyamideimide (PAI), and polyetherimide (PEI). The styrene resin includes, for example, at least one selected from the group consisting of polystyrene (PS), high-impact polystyrene, an acrylonitrile-styrene resin (AS resin), and an acrylonitrile-butadiene-styrene resin (ABS resin). The engineering plastic includes, for example, at least one selected from the group consisting of polycarbonate (PC), polyarylate (PAR), polysulfone (PSF), polyethersulfone (PES), polyphenyleneether (PPE), polyphenylene sulfide (PPS), polyetherketone (PEK), polyether-etherketone (PEEK), polyphenyleneoxide (PPO), and polyethersulfite.

### (Intermediate Layer)

The intermediate layer 23 is provided on one main surface of the base material 21, and the adhesive layer 22 is sandwiched between the base material 21 and the intermediate layer 23. The intermediate layer 23 includes a housing portion 23A for housing the recording medium 26. The housing portion 23A is provided in part of the plane of the intermediate layer 23. The housing portion 23A may be a through hole penetrating the intermediate layer 23 in the thickness direction. The intermediate layer 23 is for suppressing a step formed by the recording medium 26 when the recording medium 26 is sandwiched between the base material 21 and the overlay layer 25. The intermediate layer 23 has substantially the same thickness as that of the recording medium 26, and covers a region of one main surface of the base material 21 other than the region where the recording medium 26 is provided.

The intermediate layer 23 has a film shape. The intermediate layer 23 may have transparency. The intermediate layer 23 includes plastic. Examples of the plastic include those similar to those of the base material 21.

### (Overlay Layer)

The overlay layer 25 is provided on the intermediate layer 23 and the recording medium 26, and covers the intermediate layer 23 and the recording medium 26. The adhesive layer 24 is sandwiched between the intermediate layer 23 and the overlay layer 25 and between the recording medium 26 and the overlay layer 25. The overlay layer 25 protects the internal members of the stacked body 20 (i.e., the recording medium 26 and the intermediate layer 23), and maintains the mechanical reliability of the stacked body 20.

The overlay layer 25 has a film shape. The overlay layer 25 has transparency. The overlay layer 25 includes plastic. Examples of the plastic include those similar to those of the base material 21. A design or the like may be printed on at least one main surface of the overlay layer 25.

### (Adhesive Layer)

The adhesive layer 22 is provided between the base material 21 and the intermediate layer 23, and bonds the base material 21 and the intermediate layer 23 together. The adhesive layer 24 is provided between the intermediate layer 23 and the overlay layer 25, and bonds the intermediate layer 23 and the overlay layer 25 together. The adhesive layers 22 and 24 include a thermal adhesive. The thermal adhesive includes a thermosetting resin. The thermosetting resin includes, for example, at least one selected from the group consisting of an epoxy resin and a urethane resin. From the viewpoint of reducing damage to the recording medium 26, the curing temperature of the thermal adhesive is favorably in the temperature range of 100° C. or more and 120° C. or less.

### (Recording Medium)

The recording medium 26 is the recording medium 10 according to the first embodiment, the recording medium 10A according to the second embodiment, or the recording medium 10B according to the third embodiment.

### [4.2 Method of Producing Stacked Body]

An example of a method of producing the stacked body 20 according to the fourth embodiment will be described below.

First, a thermosetting resin is applied as a thermal adhesive onto one main surface of the base material 21 to form the adhesive layer 22. Next, after placing the intermediate layer 23 on the adhesive layer 22, the recording medium 26 is fitted into the housing portion 23A of the intermediate layer 23. Note that the intermediate layer 23 in which the recording medium 26 is fitted into the housing portion 23A in advance may be placed on the adhesive layer 22. Further, the adhesive layer 22 may be formed by applying a thermosetting resin onto the intermediate layer 23 in which the recording medium 26 is fitted into the housing portion 23A in advance and then placing the intermediate layer 23 on one main surface of the base material 21 so as to sandwich the coating film between them. Alternatively, the adhesive layer 22 may be formed by bonding a sheet formed by applying a thermosetting resin to a separator in advance to the main surface of the base material 21 or the intermediate layer 23 in which the recording medium 26 is fitted into the housing portion 23A in advance by means such as thermal lamination.

Next, a thermosetting resin is applied as a thermal adhesive onto the intermediate layer 23 to form the adhesive layer 24, and then, the overlay layer 25 is placed on the adhesive layer 24. Next, the obtained stacked body is sandwiched between metal plates and pressurized while heating to thermally cure the adhesive layer 22 and the adhesive layer 24. From the viewpoint of reducing damage to the recording medium 26, the temperature applied to the stacked body during thermal curing is favorably 100° C. or more and 120° C. or less. As a result, the desired stacked body 20 is obtained. The adhesive layer 24 may be formed by applying a thermosetting resin to the overlay layer 25 and placing the overlay layer 25 on the intermediate layer 23 so as to sandwich the coating film between them. Further, the adhesive layer 24 may be formed by bonding a sheet formed by applying a thermosetting resin to a separator in advance to the overlay layer 25 or the intermediate layer 23 by means such as thermal lamination.

### [4.3 Operation and Effect]

As described above, in the stacked body 20 according to the fourth embodiment, the base material 21 and the intermediate layer 23 are bonded together by the adhesive layer 22 including a thermal adhesive, and the intermediate layer 23 and the overlay layer 25 are bonded together by the adhesive layer 22 including a thermal adhesive. As a result, it is possible to firmly bond the base material 21 and firmly bond the intermediate layer 23 together and the intermediate layer 23 and the overlay layer 25 together. Therefore, it is possible to improve anti-tamper properties.

Since the recording medium 26 is fitted into the housing portion 23A of the intermediate layer 23, it is possible to make it difficult to visually recognize the boundary between the recording medium 26 and the intermediate layer 23 in the in-plane direction of the stacked body 20. Therefore, it becomes difficult to identify where in the plane of the stacked body 20 the recording medium 26 is provided. Therefore, it is possible to improve anti-tamper properties.

Since the recording medium 26 is enclosed within the stacked body 20, it is possible to reduce the influence of exposure to water, a chemical substance, and the like on the recording medium 26.

### 5 Fifth Embodiment

In a fifth embodiment, an example of a stacked body having a configuration different from that of the fourth embodiment will be described.

### [5.1 Configuration of Stacked Body]

FIG. 6 is a cross-sectional view showing an example of a configuration of a stacked body 20A according to the fifth embodiment. The stacked body 20A is different from the stacked body 20 according to the fourth embodiment in that it does not include the adhesive layer 22 and the adhesive layer 24, the base material 21 and the intermediate layer 23 are bonded together by fusion, and the intermediate layer 23 and the overlay layer 25 are bonded together by fusion.

In the fifth embodiment, the base material 21, the intermediate layer 23, and the overlay layer 25 favorably include a thermoplastic resin as plastic. When the base material 21, the intermediate layer 23, and the overlay layer 25 include a thermoplastic resin, the interlayer adhesion strength by fusion can be enhanced. From the viewpoint of reducing damage to the recording medium 26, the thermoplastic resin is favorably one capable of thermally fuse the layers of the stacked body 20A in a temperature range of 130° C. or more and 200° C. or less.

The base material 21, the intermediate layer 23, and the overlay layer 25 may include the same type of thermoplastic resin, or the base material 21, the intermediate layer 23, and the overlay layer 25 do not necessarily need to include the same type of thermoplastic resin. In the case where the base material 21, the intermediate layer 23, and the overlay layer 25 do not include the same type of thermoplastic resin, one layer of the base material 21, the intermediate layer 23, and the overlay layer 25 may include a thermoplastic resin of a type different from those of the other two layers, or the base material 21, the intermediate layer 23, and the overlay layer 25 may include different types of thermoplastic resins.

In the case where the base material 21, the intermediate layer 23, and the overlay layer 25 include the same type of thermoplastic resin, the base material 21, the intermediate layer 23, and the overlay layer 25 favorably include at least one selected from the group consisting of a semi-crystalline thermoplastic resin and an amorphous thermoplastic resin from the viewpoint of improving the interlayer adhesion strength by fusion.

The semi-crystalline thermoplastic resin includes, for example, at least one selected from the group consisting of polypropylene (PP), polyethylene (PE), polyacetal (POM), polyethylene terephthalate (PET), polybutylene terephthalate (PBT), polyphenylene sulfide (PPS), and polyetheretherketone (PEEK).

The amorphous thermoplastic resin includes, for example, at least one selected from the group consisting of an ABS resin, polycarbonate (PC), a polymer alloy of an ABS resin and PC (hereinafter, referred to as an “ABS/PC polymer alloy”.), an AS resin, polystyrene (PS), polymethylmethacrylate (PMMA), polyphenyleneoxide (PPO), polysulfone (PSU), polyvinyl chloride (PVC), polyetherimide (PEI), and polyethersulfone (PES).

In the case where the base material 21, the intermediate layer 23, and the overlay layer 25 do not include the same type of thermoplastic resin, the base material 21, the intermediate layer 23, and the overlay layer 25 favorably include an amorphous thermoplastic resin from the viewpoint of improving the interlayer adhesion strength by fusion.

The following combinations are favorable as combinations of amorphous thermoplastic resins included in two adjacent layers of the stacked body 20A. In the case where one of adjacent two layers of the stacked body 20A includes an ABS resin, the other layer favorably includes at least one selected from the group consisting of an ABS/PC polymer alloy, polycarbonate (PC), an AS resin, polystyrene (PS), polymethylmethacrylate (PMMA), and polyvinyl chloride (PVC).

In the case where one of adjacent two layers of the stacked body 20A includes an ABS/PC polymer alloy, the other layer favorably includes at least one selected from the group consisting of an ABS resin, polycarbonate (PC), and polymethylmethacrylate (PMMA). In the case where one of adjacent two layers of the stacked body 20A includes polycarbonate (PC), the other layer favorably includes at least one selected from the group consisting of an ABS resin, an ABS/PC polymer alloy, and polymethylmethacrylate (PMMA).

In the case where one of adjacent two layers of the stacked body 20A includes an AS resin, the other layer favorably includes at least one selected from the group consisting of an ABS resin, polystyrene (PS), polymethylmethacrylate (PMMA), and polyphenyleneoxide (PPO). In the case where one of adjacent two layers of the stacked body 20A includes polystyrene (PS), the other layer favorably includes at least one selected from the group consisting of an AS resin and polyphenyleneoxide (PPO).

In the case where one of adjacent two layers of the stacked body 20A includes polymethylmethacrylate (PMMA), the other layer favorably includes at least one selected from the group consisting of an ABS resin, an ABS/PC polymer alloy, an AS resin, and polyphenyleneoxide (PPO). In the case where one of adjacent two layers of the stacked body 20A includes polyphenyleneoxide (PPO), the other layer favorably includes at least one selected from the group consisting of polycarbonate (PC), an AS resin, polystyrene (PS), and polymethylmethacrylate (PMMA).

In the case where one of adjacent two layers of the stacked body 20A includes polysulfone (PSU), the other layer favorably includes polycarbonate (PC). In the case where one of adjacent two layers of the stacked body 20A includes polyvinyl chloride (PVC), the other layer favorably includes an ABS resin.

### [5.2 Method of Producing Stacked Body]

An example of a method of producing the stacked body 20 according to the fifth embodiment will be described.

First, the intermediate layer 23 is placed on one main surface of the base material 21, and then, the recording medium 26 is fitted into the housing portion 23A of the intermediate layer 23. Note that the intermediate layer 23 in which the recording medium 26 is fitted into the housing portion 23A in advance may be placed on one main surface of the base material 21. Next, the overlay layer 25 is placed on the intermediate layer 23. Next, the obtained stacked body is sandwiched between metal plates and pressurized while heating to thermally fuse the base material 21 and the intermediate layer 23 and thermally fuse the intermediate layer 23 and the overlay layer 25. The temperature applied to the stacked body during thermal fusion is favorably 130° C. or more and 200° C. or less from the viewpoint of reducing damage to the recording medium 26 and exhibiting sufficient fusion strength. As a result, the desired stacked body 20A is obtained.

### [5.3 Operation and Effect]

As described above, in the stacked body 20A according to the fifth embodiment, the base material 21 and the intermediate layer 23, and the intermediate layer 23 and the overlay layer 25 are fused. As a result, it is possible to firmly bond the base material 21 and the intermediate layer 23 together and firmly bond the intermediate layer 23 and the overlay layer 25 together. Therefore, it is possible to improve anti-tamper properties.

### 6 Modified Examples

### Modified Example 1

Although an example in which the intermediate layers 14A and 14B are thermal insulation layers having a single-layer structure has been described in the second embodiment, the intermediate layers 14A and 14B may be thermal insulation layers having a multilayer structure. The thermal insulation layer having a multilayer structure may include a resin layer and a bonding layer provided on one main surface of the resin layer, or may include a resin layer and bonding layers provided on both surfaces of the resin layer. Note that the configuration of the thermal insulation layer having a multilayer structure is not limited to the above configuration. Further, the number of layers of the multilayer structure is also not limited to the above two layers and three layers, and a structure having four or more layers may be adopted.

The resin layer may be a polymer film or a coat layer such as a UV curable resin layer. The bonding layer is, for example, an adhesion layer or an adhesive layer. The bonding layer may be a double-sided adhesion film such as an OCA (Optical Clear Adhesive). The double-sided adhesion film may include only an adhesion layer, or may include a film as a base material, a first adhesion layer provided on a first surface of the film, and a second adhesion layer provided on a second surface of the film.

### Modified Example 2

Although an example in which the recording medium 10A includes the three recording layers 12A, 12B, and 12C and the two intermediate layers 14A and 14B has been described in the second embodiment, the recording medium 10A may include a plurality of (other than three) recording layers and a plurality of (other than two) intermediate layers. The plurality of recording layers and the plurality of intermediate layers may be stacked such that a recording layer and an intermediate layer are alternately located. The plurality of recording layers may be capable of exhibiting different hues in the colored state. That is, the coloring compound included in each of the plurality of recording layers may be capable of exhibiting a different hue in the colored state. The photothermal conversion agent included in each of the plurality of recording layers may have a different absorption wavelength peak.

### Modified Example 3

Although an example in which the recording layer 15 includes the three types of microcapsules 15A, 15B, and 15C has been described in the third embodiment, a plurality of (other than three) types of microcapsules may be included. Each of the plurality of types of microcapsules may be capable of exhibiting a different view in the colored state. That is, the coloring compound included in the plurality of types of microcapsules may be capable of exhibiting a different hue in the colored state. The photothermal conversion agent included in each of the plurality of types of microcapsules may have a different absorption wavelength peak.

### Modified Example 4

Although examples in which the recording media 10, 10A, and 10B include the base material 11 has been described in the first to third embodiments, respectively, the recording media 10, 10A, and 10B do not necessarily need to include the base material 11.

### Modified Example 5

Although an example in which the protective layer 13 is provided on the recording layer 12 has been described in the first embodiment, a UV cut layer may be provided between the recording layer 12 and the protective layer 13. By providing a UV cut layer, UV light that enters the recording layer 12 can be cut, so that it is possible to prevent the recording layer 12 from deteriorating due to UV light. Similarly, in the second embodiment, a UV cut layer may be provided between the recording layer 12C and the protective layer 13. Similarly, in the third embodiment, a UV cut layer may be provided between the recording layer 15 and the protective layer 13.

### Other Modified Examples

Although embodiments and modified examples of the present disclosure have been specifically described, the present disclosure is not limited to the above embodiments and modified examples, and various modifications can be made on the basis of the technical idea of the present disclosure.

For example, the configurations, methods, processes, shapes, materials, numerical values, and the like mentioned in the above embodiments and modified examples are merely examples, and configurations, methods, processes, shapes, materials, numerical values, and the like different from these may be used as necessary.

The configurations, methods, processes, shapes, materials, numerical values, and the like in the above embodiments and modified examples can be combined with each other without departing from the essence of the present disclosure.

In numerical ranges described in a stepwise manner in the above embodiments and modified examples, the upper limit value or the lower limit value in a numerical range at one stage may be replaced with the upper limit value or the lower limit value in a numerical range at another stage.

The materials exemplified in the above embodiments and modified examples can be used alone or two or more of them can be used in combination, unless otherwise specified.

Further, the present disclosure may also take the following configurations.
(1) A recording medium, including:
   a recording layer that includes a coloring compound with electron-donating properties and a color developer with electron acceptability,
   the color developer including a compound represented by the following formula (1).

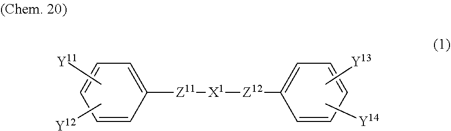

(in which, in the formula (1), X¹ represents a divalent group that has at least one benzene ring. Y¹¹, Y¹², Y¹³, and Y¹⁴ independently represent a monovalent group. Z¹¹ and Z¹² independently represent a hydrogen-bonding group.)
(2) The recording medium according to (1), in which the recording layer further includes a polycarbonate resin.
(3) The recording medium according to (1) or (2), in which
   Z¹¹ and Z¹² in the formula (1) independently represent a urea bond (—NHCONH—), an amide bond (—NHCO—, —OCHN—), or a hydrazide bond (—NHCOCONH—).
(4) The recording medium according to (1) or (2), in which
   Z¹¹ and Z¹² in the formula (1) represent a urea bond (—NHCONH—).
(5) The recording medium according to any one of (1) to (4), in which
   Y¹¹ and Y¹³ in the formula (1) represent a hydroxy group (—OH).
(6) The recording medium according to any one of (1) to (5), in which
   X¹ in the formula (1) represents a divalent group having at least two benzene rings.
(7) The recording medium according to any one of (1) to (6), in which
   each of a benzene ring having Y¹¹ and Y¹² and/or a benzene ring having Y¹² and Y¹³ in the formula (1) is a weak acid.
(8) The recording medium according to any one of (1) to (7), in which
   X¹ in the formula (1) represents a divalent group represented by the following formula (3).

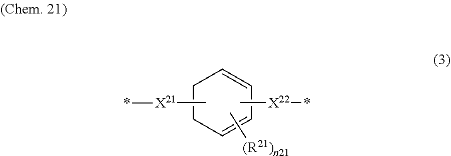

(in which, in the formula (3), X²¹ does not necessarily need to be present and represents a divalent group when X²¹ is present. X²² does not necessarily need to be present and represents a divalent group when X²² is present. R²¹ represents a monovalent group. n21 represents an integer from 0 to 4. When n21 represents an integer from 2 to 4, each R²¹ may be the same or different. A mark * represents a bonding portion.)
(9) The recording medium according to any one of (1) to (7), in which
   X¹ in the formula (1) represents a divalent group represented by the following formula (4).

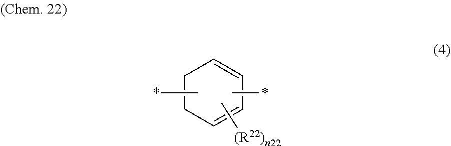

(in which, in the formula (4), R²² represents a monovalent group. n22 represents an integer from 0 to 4. When n22 represents an integer from 2 to 4, each R²² may be the same or different. A mark * represents a bonding portion.)
(10) The recording medium according to any one of (1) to (7), in which
   X¹ in the formula (1) represents a divalent group represented by the following formula (5).

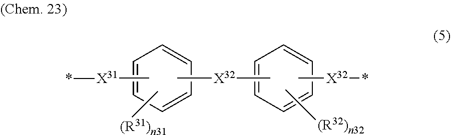

(in which, in the formula (5), X³¹ does not necessarily need to be present and represents a divalent group when X³¹ is present. X³² does not necessarily need to be present and represents a divalent group when X³² is present. X³³ does not necessarily need to be present and represents a divalent group when X³³ is present. R³¹ and R³² independently represent a monovalent group. n31 and n32 independently represent an integer from 0 to 4. When n31 represents an integer from 2 to 4, R³¹ may be the same or different. When n32 represents an integer from 2 to 4, R³² may be the same or different. A mark * represents a bonding portion.)
(11) The recording medium according to any one of (1) to (7), in which
   X¹ in the formula (1) represents a divalent group represented by the following formula (6).

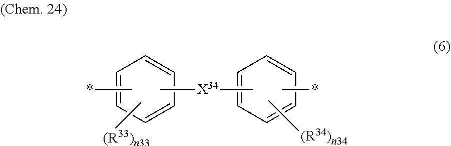

(in which, in the formula (6), X₃₄ represents a divalent group. R₃₃ and R₃₄ independently represent a monovalent group. n33 and n34 independently represent an integer from 0 to 4. When n33 represents an integer from 2 to 4, R₃₃ may be the same or different. When n34 represents an integer from 2 to 4, R₃₄ may be the same or different. A mark * represents a bonding portion.)
(12) The recording medium according to any one of (1) to (11), in which
   the recording layer includes a plurality of recording layers, and
   the coloring compound included in each of the plurality of recording layers is capable of exhibiting a different hue in a colored state.
(13) The recording medium according to (12), in which
   each of the plurality of recording layers includes a photothermal conversion agent, and
   the photothermal conversion agent included in each of the plurality of recording layers has a different absorption wavelength peak.
(14) The recording medium according to any one of (1) to (11), in which
   the recording layer includes a plurality of types of capsules,
   each of the plurality of types of capsules includes the coloring compound and the color developer, and
   the coloring compound included in each of the plurality of types of capsules is capable of exhibiting a different hue in a colored state.
(15) The recording medium according to (14), in which
   the plurality of types of capsules includes a photothermal conversion agent, and
   the photothermal conversion agent included in each of the plurality of types of capsules has a different absorption wavelength peak.
(16) A recording medium, including:
   a recording layer that includes a coloring compound with electron-donating properties and a color developer with electron acceptability,
   the color developer including a compound represented by the following formula (a).

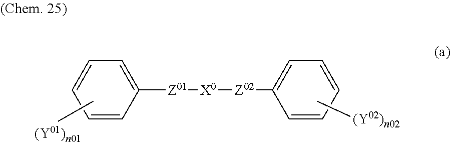

(in which, in the formula (a), X⁰ represents a divalent group that has at least one benzene ring. Y^{0′} and Y⁰² independently represent a monovalent group. n01 and n02 independently represent an integer from 0 to 5. When n01 represents an integer from 2 to 5, each Y⁰¹ may be the same or different. When n02 represents an integer from 2 to 5, Y⁰² may be the same or different. Z⁰¹ and Z⁰² independently represent a hydrogen-bonding group.)
(17) A card, including:
   the recording medium according to any one of (1) to (16).
(18) A booklet, including:
   the recording medium according to any one of (1) to (16).

### 7 Application Examples

Next, application examples of the recording media 10, 10A, and 10B according to the above first, second, and third embodiments and modified examples will be described. However, the configuration of an electronic apparatus and the like described below is merely an example, and the configuration can be appropriately changed. The above recording media 10, 10A, and 10B are applicable to various electronic apparatuses and some accessories, and the types of electronic apparatuses and accessories are not particularly limited. Specifically, for example, they are applicable to some of accessories such as a watch, a bag, clothes, a hat, glasses, and shoes as a wearable terminal. Further, they are applicable to not only electronic apparatuses and accessories but also, for example, an exterior member of an inner wall or outer wall of a building, and an exterior member of furniture such as a desk.

Although examples in which the recording medium 10 is applied to an identity card, a card, an electronic apparatus, and the like will be described in the following application examples 1 to 10, any of the recording media 10A and 10B can be applied to an identity card, a card, an electronic apparatus, and the like instead of the recording medium 10, and two or more of the recording media 10, 10A, and 10B can be combined and applied to an identity card, a card, an electronic apparatus, and the like. Further, in the following application examples 1 to 10, an example in which a predetermined image is drawn on the recording medium 10 and a recorded area and an unrecorded area are formed in the recording layer 12 will be described.

### Application Example 1

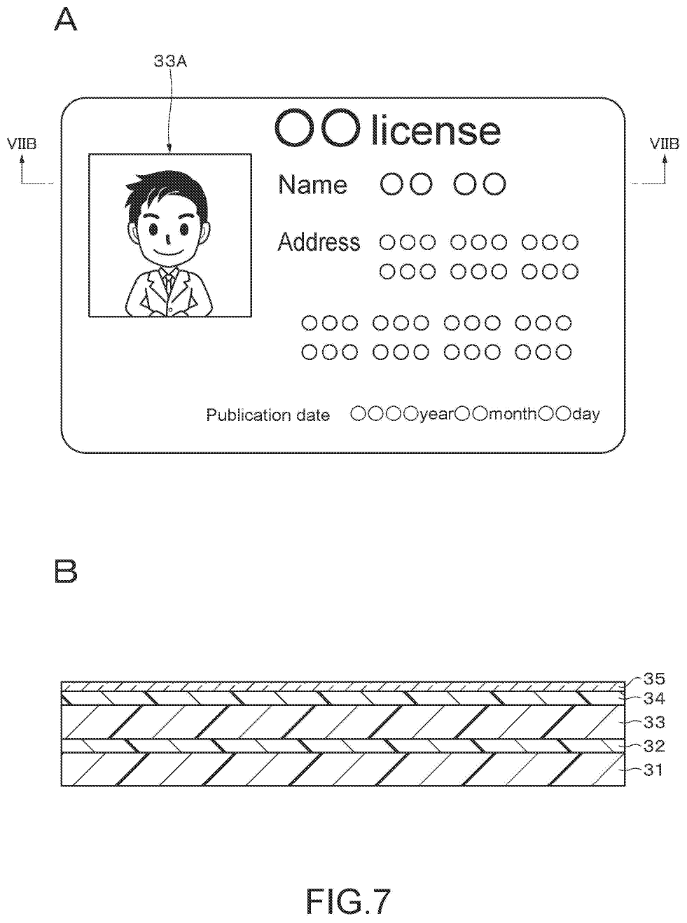

Part A of FIG. 7 shows the appearance of a card-type identity card. Part B of FIG. 7 is a cross-sectional view taken along the line VIIB-VIIB in Part A of FIG. 7. The card-type identity card is an example of a card or an identity card. The card-type identity card includes a base material 31, a bonding layer 32, a recording medium 33, a bonding layer 34, and an overlay layer 35 in this order. Although an example in which the recording medium 33 is provided on one surface of the base material 31 will be described here, the recording medium 33 may be provided on both surfaces of the base material 31.

The base material 31 is a support base material that supports the recording medium 33. The base material 31 is, for example, a plastic substrate. The recording medium 33 is the recording medium 10. The bonding layer 32 bonds the base material 31 and the recording medium 33 to each other. The bonding layer 34 bonds the recording medium 33 and the overlay layer 35 to each other. The overlay layer 35 protects the recording medium 33. The overlay layer 35 covers one surface of the recording medium 33.

Specific examples of the card-type identity card include a driver's license, a health insurance card, a basic resident register card, and a personal number card (my number card).

### Application Example 2

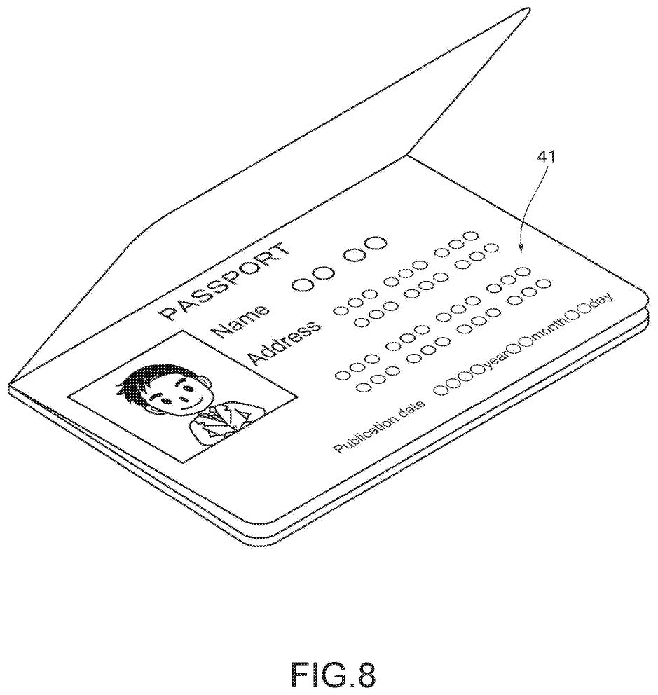

FIG. 8 shows the appearance of a booklet-type identity card. The booklet-type identity card is an example of a booklet. The booklet-type identity card includes a plurality of sheets 41. The plurality of sheets 41 is saddle stitched. The recording medium 10 is provided on at least one surface of the sheet 41. A character, a numerical value, a face photo, and the like are drawn on the recording medium 10. Specific examples of the booklet-type identity card include a passport.

### Application Example 3

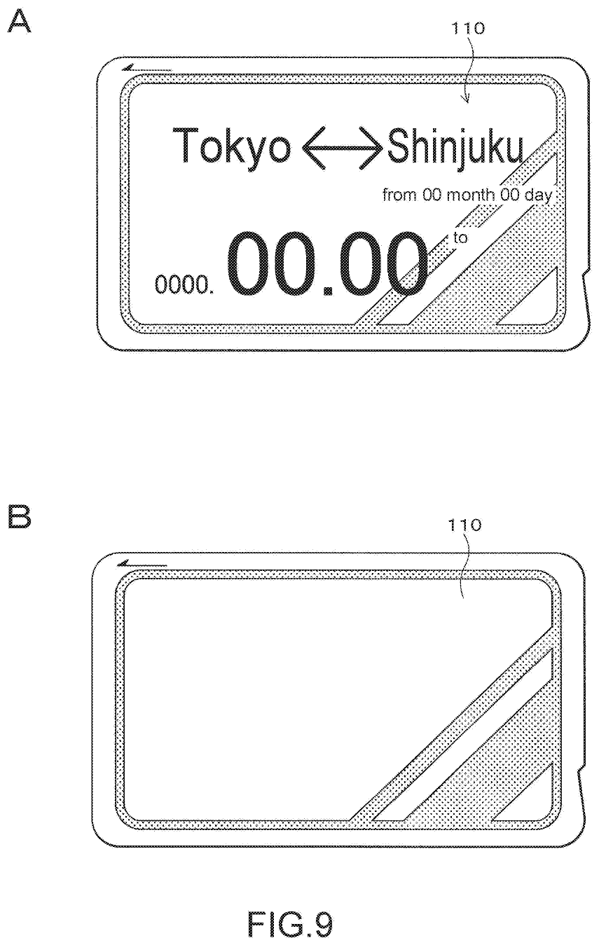

Part A of FIG. 9 and Part B of FIG. 9 show the appearance of an integrated circuit (IC) card with a rewrite function. In this IC card, the front surface of the card is a print surface 110, and a sheet-shaped recording medium 10 is provided on the print surface 110. By providing the recording medium 10 on the print surface 110 of the IC card, it is possible to draw a desired image or the like on the print surface 110 as shown in Part A of FIG. 9 and Part B of FIG. 9.

### Application Example 4

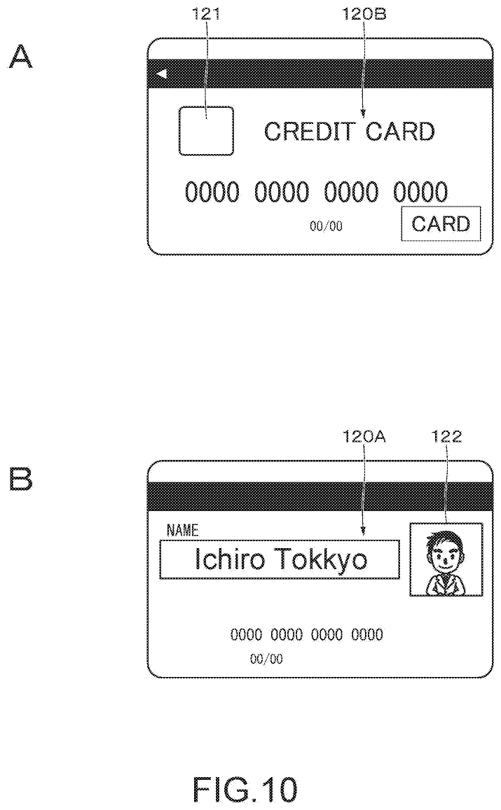

Part A of FIG. 10 and Part B of FIG. 10 show the appearance of a credit card with an IC chip. The credit card with an IC chip is another example of the IC card. The credit card includes an IC chip 121 on a front surface (first surface) 120B, and a face photo 122 on a back surface (second surface) 120A. By providing the recording medium 10 on the front surface 120B and the back surface120A of the credit card, it is possible to draw on the front surface 120B and the back surface 120A of the credit card as shown in Part A of FIG. 10 and Part B of FIG. 10.

### Application Example 5

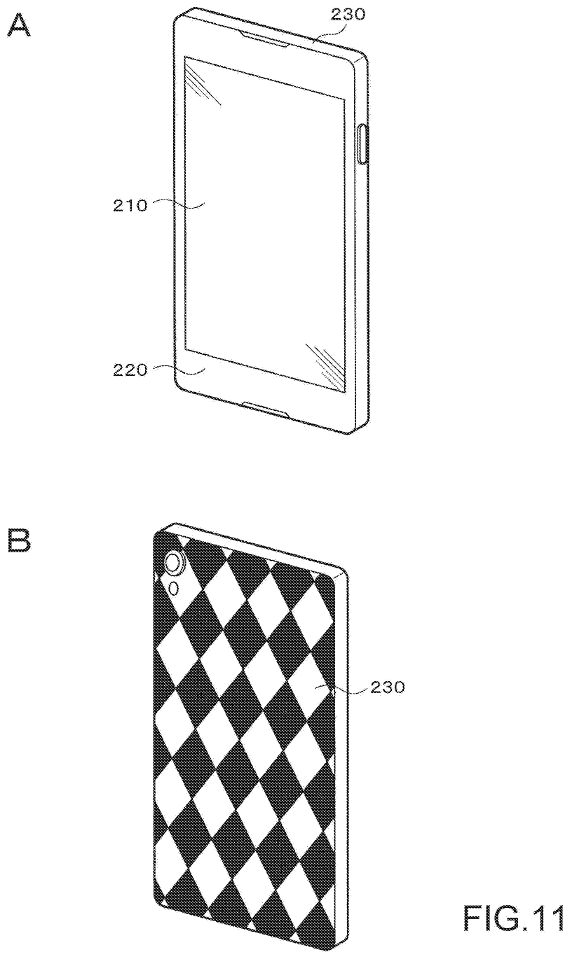

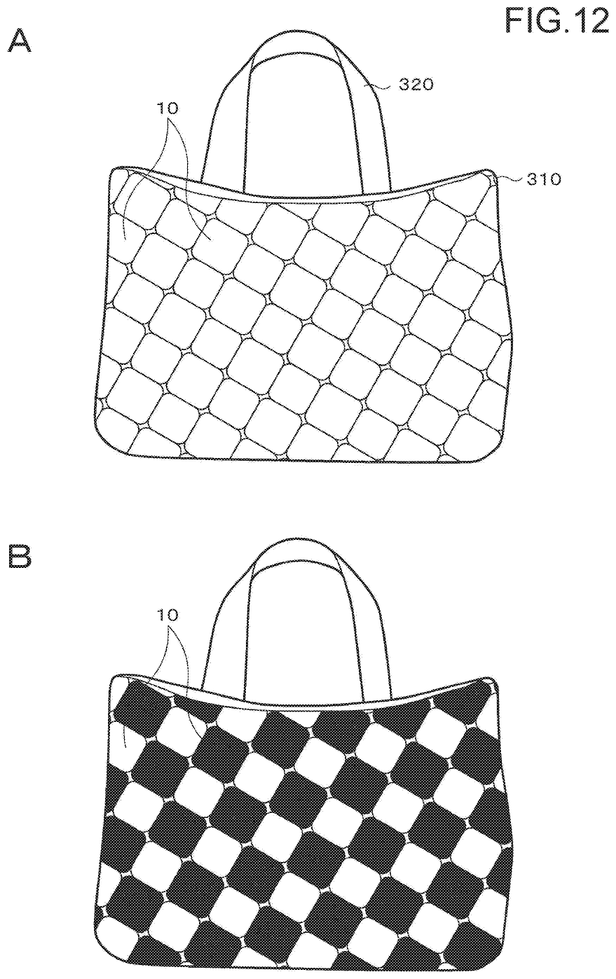

Part A of FIG. 11 shows an external configuration of a front surface of a smartphone. Part B of FIG. 11 shows an external configuration of a back surface of the smartphone shown in Part A of FIG. 11. This smartphone includes, for example, a display portion 210, a non-display portion 220, and a casing 230. For example, the recording medium 10 is provided as an exterior member of the casing 230 on, for example, one surface of the casing 230 on the back surface side. This makes it possible to display various color patterns as shown in Part B of FIG. 11. Note that although a smartphone has been taken as an example here, the present disclosure is not limited thereto and is applicable to, for example, a notebook personal computer (PC), a tablet PC, and the like.

### Application Example 6

Part A of FIG. 12 and Part B of FIG. 12 show the appearance of a bag. This bag includes, for example, a compartment 310 and a handle 320, and the recording medium 10 is provided in the compartment 310. As a result, it is possible to display various characters, designs, and the like on the compartment 310. Further, by attaching the recording medium 10 to the portion of the handle 320, it is possible to display various color patterns. As shown in the example of Part A of FIG. 12 and Part B of FIG. 12, the design of the compartment 310 can be changed. It is possible to realize an electronic device that is useful also in fashion applications.

### Application Example 7

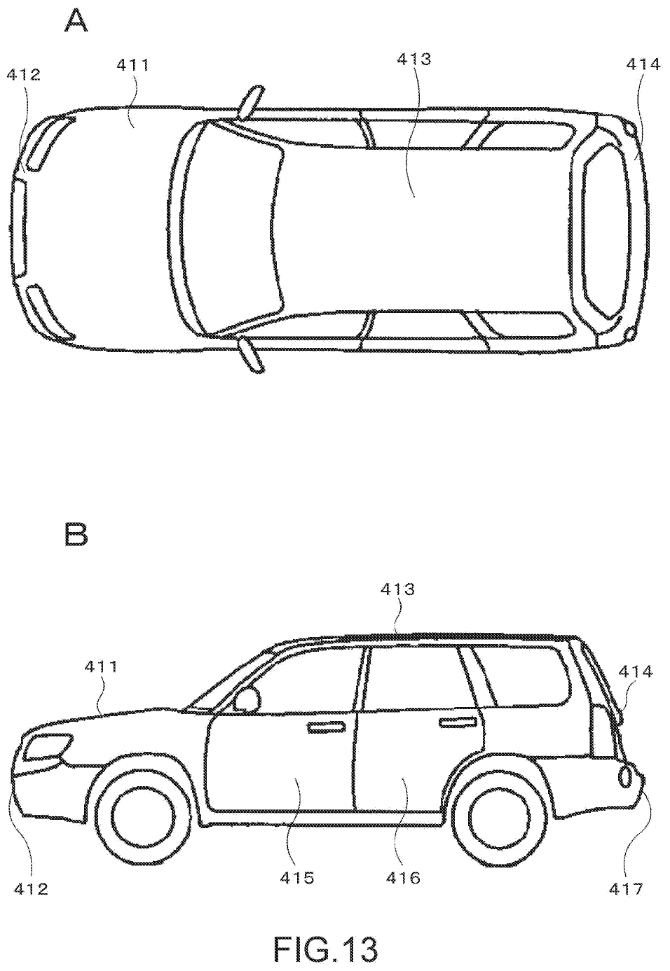

Part A of FIG. 13 shows the appearance of a top surface of an automobile, and Part B of FIG. 13 shows the appearance of a side surface of the automobile. By providing the recording medium 10 on, for example, a vehicle body such as a bonnet 411, a bumper 412, a roof 413, a trunk cover 414, a front door 415, a rear door 416, and a rear bumper 417, it is possible to display various types of information and color patterns on the respective portions. Further, by providing the recording medium 10 in the interior of an automobile, such as a steering wheel and a dashboard, it is possible to display various color patterns.

### Application Example 8

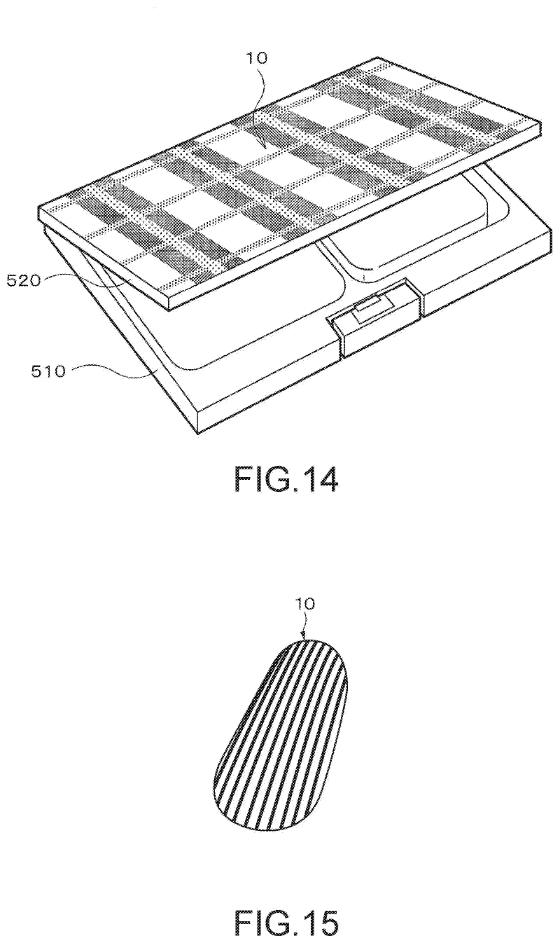

FIG. 14 shows the appearance of a cosmetic container. This cosmetic container includes a housing portion 510 and a lid 520 that covers the housing portion 510, and the recording medium 10 is provided on the lid 520. This recording medium 10 decorates the lid 520 with, for example, a design shown in FIG. 14, a color pattern, or a character. The design of this lid 520, color pattern, character, and the like can be written by a predetermined drawing device. Note that the recording medium 10 can be attached to not only the front surface (lid 520) of the cosmetic container but also the back surface (housing portion 510) or the like.

### Application Example 9

FIG. 15 shows the appearance of a nail tip. The nail tip is an example of an exterior member. The nail tip includes the recording medium 10 on the front surface. When the nail tip includes the recording medium 10 on the front surface in this way, it is possible to display various color patterns. Note that although a configuration in which a nail tip includes the recording medium 10 on the front surface has been described in the above example, the configuration of the nail tip is not limited thereto and the recording medium 10 itself may be a nail tip. In this case, the base material 11 has a nail shape.

### Application Example 10

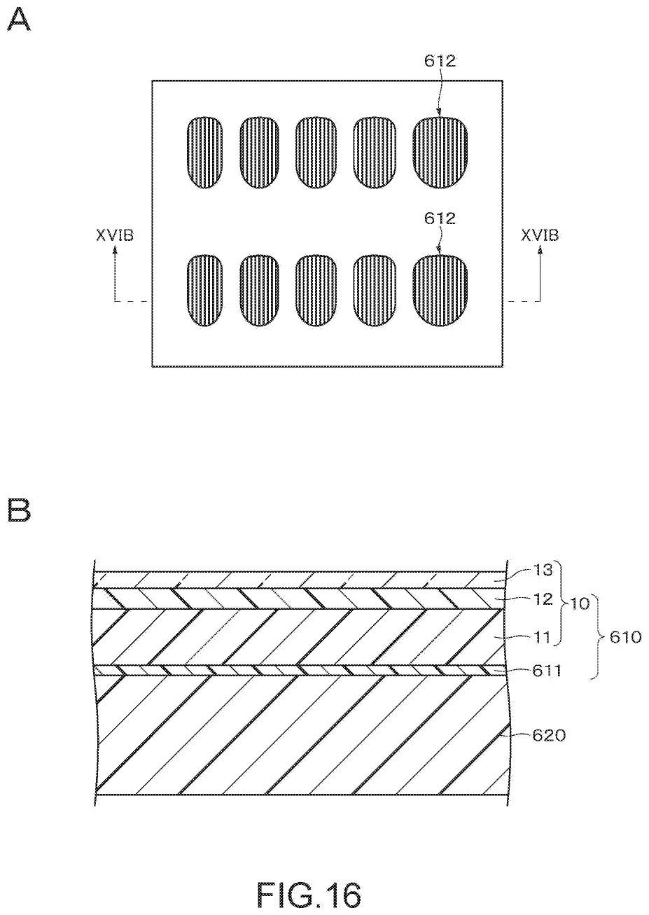

Part A of FIG. 16 shows the appearance of a nail sticker. Part B of FIG. 16 shows the cross section taken along the line XVIB-XVIB in Part A of FIG. 16. The nail sticker is an example of an exterior member. The nail sticker includes a recording medium with an adhesive layer 610 and a release sheet 620. The recording medium with an adhesive layer 610 includes the recording medium 10 and an adhesion layer 611. When the recording medium with an adhesive layer 610 includes the recording medium 10 in this way, it is possible to display various color patterns. The adhesion layer 611 is provided on the surface of the recording medium 10 on the side of the base material 11. The recording medium 10 may further include the protective layer 13 on the recording layer 12.

The recording medium 10 and the like include a plurality of nail sticker portions 612 to be attached to the nails of fingers of both hands. The nail sticker portion 612 is held in a cut or half-cut state relative to the nail sticker and is configured to be peelable on the interface between the adhesion layer 611 and the release sheet 620.

Although examples in which the present disclosure is applied to a nail tip and a nail sticker have been described in the application examples 9 and 10, the application example of the present disclosure to nails is not limited thereto. For example, the recording layer 12 may be directly formed on a bare nail (human nail) as a support base material. The recording layer 12 may be formed by applying a paint to the bare nail and curing it, or the recording layer 12 having self-supporting properties may be separately formed and attached to the bare nail.

### 8 Examples

Although the present disclosure will be specifically described by way of Examples, the present disclosure is not limited to these Examples.

### Examples 1 to 9

### (Process of Preparing Paint for Forming Recording Layer)

First, polycarbonate (PC) as a matrix resin was dissolved in methyl ethyl ketone (MEK), a color developer was added thereto, and the mixture was dispersed using a rocking mill. As the color developer, different color developers (compounds represented by the formulae (2A) to (10A)) were used in Examples 1 to 9 as shown in Table 1. Next, a leuco dye that exhibits a magenta color in the colored state and is represented by the above formula (2) was added, and the mixture was prepared such that the final ratio (mass ratio) was leuco dye:color developer:polycarbonate=1:2:4. Further, a photothermal conversion material having a phthalocyanine skeleton was added to prepare a paint for forming a recording layer. Note that the mixing amount of the photothermal conversion material was such that the absorbance during coating was 0.32.

### (Process of Forming Recording Layer)

Next, a paint for forming a recording layer was applied onto a PET (support base) having a thickness of 50 μm using a wire bar, and dried at 110° C. for 5 minutes to obtain a recording layer. At this time, the conditions for applying the paint for forming a recording layer were adjusted such that the film thickness of the dried recording layer was the value shown in Table 1. Next, by applying laser light to the recording layer, a colored portion and an uncolored portion (background) were formed. In this way, a desired recording medium was obtained.

### Example 10

A recording medium was obtained in a way similar to that in Example 2 except that a leuco dye that exhibits a yellow color in the colored state was mixed as a leuco dye in the process of preparing a paint for forming a recording layer.

### Example 11

A recording medium was obtained in a way similar to that in Example 2 except that a leuco dye that exhibits a cyan color in the colored state was mixed as a leuco dye in the process of preparing a paint for forming a recording layer.

### Example 12

A recording medium was obtained in a way similar to that in Example 11 except that a light stabilizer (Hostavin N-30 manufactured by Clariant) was further mixed in the paint for forming a recording layer in the process of preparing a paint for forming a recording layer. The mixing amount of the light stabilizer was set to 1.4 parts by mass with respect to 100 parts by mass of the total amount of the leuco dye, the color developer, polycarbonate, the photothermal conversion material, and the light stabilizer.

### Example 13

A recording medium was obtained in a way similar to that in Example 2 except that polyvinyl chloride-vinyl acetate copolymer (PVC) was mixed as a matrix resin instead of polycarbonate (PC) in the process of preparing a paint for forming a recording layer.

### Comparative Examples 1 to 4

In the process of preparing a paint for forming a recording layer, as a color developer, different color developers (compounds represented by the formulae (1B) to (4B)) were used in Comparative Examples 1 to 4 as shown in Table 1. Further, in the process of applying a paint for forming a recording layer, the conditions for applying a paint for forming a recording layer were adjusted such that the film thickness of the dried recording layer was the value shown in Table 1. A recording medium was obtained in a way similar to that in Example 1 except for the above.

### [Evaluation]

The recording media obtained as described above were evaluated as follows.

### (Evaluation of OD in Standard Environment)

The OD of the colored portion of the recording medium was measured three times at the same position in a standard environment (23° C., 50 RH %), and the measured values were simply averaged (arithmetically averaged) to obtain the average OD of the colored portion. The ODs of C (cyan), M (magenta), and Y (yellow) corresponding to the visually recognized colors were used as the ODs of the respective colors. The average OD of the uncolored portion (background) of the recording medium was obtained in a way similar to that for the average OD of the colored portion of the recording medium.

The conditions for measuring OD are as follows.
Measuring apparatus: Spectrophotometer (Xrite eXact manufactured by X-Rite, Incorporated)
Measurement diameter: 2.0 mm
Illuminant: D50
Standard observer: 2°
Measurement conditions: No filter (MO)

Next, the average OD of the colored portion and the average OD of the uncolored portion were respectively converted into the average OD of the colored portion in the recording layer having a film thickness of 5 μm and the average OD of the uncolored portion in the recording layer having a film thickness of 5 μm. Table 1 shows the average OD of the colored portion before and after conversion, and the average OD of the uncolored portion before and after conversion.

Next, the average OD of the uncolored portion (unrecorded area) after conversion was evaluated at the following two stages. The evaluation results were shown in Table 1.

Evaluation 2: The average OD of the uncolored portion (unrecorded area) after conversion is 0.30 or less.

Evaluation 1: The average OD of the uncolored portion (unrecorded area) after conversion exceeds 0.30.

Since the color development is generally recognizable to anyone when the average OD of the uncolored portion (unrecorded area) after conversion exceeds 0.30, the reference value for determination in the two-stage evaluation was set to 0.30 of the average OD of the uncolored portion (unrecorded area) after conversion.

### (Evaluation of Preservation Stability in High-Temperature and Low-Humidity Environment)

First, a preservation test was conducted by preserving the recording medium under high-temperature and low-humidity conditions of 80° C. and 30% RH for 200 hours. The condition of the temperature of 80° C. in the preservation test is the highest temperature in the preservation test for all parts. If a good result is obtained in the preservation test at this temperature, the recording medium is presumably capable of withstanding preservation under various environments. Next, the average OD of the colored portion in the recording layer having a film thickness of 5 μm was obtained in a way similar to that for the above “evaluation of OD in standard environment”. Next, regarding the colored portion, the OD maintenance rate of the colored portion before and after the preservation test was obtained using the following formula.

(The OD maintenance rate of the colored portion before and after the preservation test) [%]=((The average OD of the colored portion after the preservation test)/(The average OD of the colored portion before the preservation test))×100

Note that as the average OD of the colored portion before the preservation test, the average OD of the colored portion in the recording layer having a film thickness of 5 μm, which was obtained in the above “Evaluation of OD in standard environment”, was used.

Next, the OD maintenance rate of the colored portion before and after the preservation test was evaluated in the following two stages. The evaluation results were shown in Table 1.

Evaluation 2: The OD maintenance rate of the colored portion before and after the preservation test is 85% or more.

Evaluation 1: The OD maintenance rate of the colored portion before and after the preservation test is less than 85%.

Since the change from the original color is generally noticeable to anyone when the OD maintenance rate of the colored portion before and after the preservation test is less than 85%, the reference value for determination in the two-stage evaluation was set to 85% of the OD maintenance rate.

### (Evaluation of Preservation Stability in High-Temperature and High-Humidity Environment)

The OD maintenance rate of the colored portion before and after the preservation test was obtained in a way similar that in the above “Evaluation of preservation stability in high-temperature and low-humidity environment” except that the preservation test was conducted by preserving the recording medium under high-temperature and high-humidity conditions of 80° C. and 60% RH for 200 hours. Subsequently, the preservation stability was evaluated in two stages in a way similar to that in the above “Evaluation of preservation stability in high-temperature and low-humidity environment”. The evaluation results are shown in Table 1.

### (Evaluation (1) of Heat Resistance)

First, an unheated recording medium was prepared and used as a sample A. Next, L*, a*, and b* of the uncolored portion of the sample A were measured three times at the same position in a standard environment (23° C., 50 RH %), and the measured values were simply averaged (arithmetically averaged) to obtain an average L*, an average a*, and an average b* of the uncolored portion (hereinafter, referred to as “L₀*, a₀*, and b₀*”.). Next, an unheated recording medium was placed in an oven (manufactured by AS ONE Corporation, ETTAS vacuum dryer AVO-250V) heated to 150° C. in advance for 30 minutes and used as a sample B. Next, L*, a*, and b* of the uncolored portion of the sample B were measured three times at the same position, and the measured values were simply averaged (arithmetically averaged) to obtain an average *, an average a*, and an average b* of the uncolored portion (hereinafter, referred to as “L₁*, a₁*, and b₁*”.). The measurement conditions for L*, a*, and b* are as follows.

Measuring apparatus: Spectrophotometer (Xrite eXact manufactured by X-Rite, Incorporated)
Measurement diameter: 2.0 mm
Illuminant: D50
Standard observer: 2°
Measurement conditions: No filter (MO)

Next, ΔE_{ab}* of the uncolored portion with reference to the sample A was calculated using the following formula.

$$Δ {E}_{ab}^{*} = \sqrt{{( {L}_{0}^{*} - {L}_{1}^{*} )}^{2} + {( {a}_{0}^{*} - {a}_{1}^{*} )}^{2} + {( {b}_{0}^{*} - {b}_{1}^{*} )}^{2}} \qquad ( Math . 1 )$$

Next, ΔE_{ab}* was evaluated in the following three stages. The evaluation results are shown in Table 1.
Evaluation 3: ΔE_{ab}*<3.2
Evaluation 2: 3.2≤ΔE_{ab}*<6.5
Evaluation 1: 6.5≤ΔE_{ab}*

ΔE_{ab}*<3.2 means that ΔE_{ab}* is a class A tolerance or smaller than that. Note that the class A tolerance means a color difference level that is hardly noticeable in color separation comparisons, i.e., a level at which the color is generally considered to be the same color.

3.2≤ΔE_{ab}*<6.5 means that ΔE_{ab}* is a class B tolerance. Note that the class B tolerance means a range that can be treated as the same color at an impression level.

6.5≤ΔE_{ab}* means that ΔE_{ab}* is a class C tolerance or larger than that. Note that the class C tolerance means a color difference corresponding to one step in JIS standard color chart, Munsell color chart, or the like.

### (Evaluation (2) of Heat Resistance)

An unheated recording medium was placed in an oven (manufactured by AS ONE Corporation, ETTAS vacuum dryer AVO-250V) heated to 180° C. in advance and used as the sample B. ΔE_{ab}* with reference to the sample A was calculated in a way similar to that in the “Evaluation (1) of heat resistance”. Next, ΔE_{ab}* was evaluated in three stages similarly to that in the “Evaluation (1) of heat resistance”. The evaluation results are shown in Table 1.

### (Evaluation of Light Resistance)

The following light resistance evaluation was performed on the recording media according to the Examples 2 and 13.

First, a UV cut barrier was formed on the recording layer of each of the recording media according to Examples 2 and 13 obtained as described above and then the average OD of each of the colored portion the uncolored portion was obtained. Next, an accelerated light resistance test (test conditions: irradiance of 60 W/m², black panel temperature of 63° C., irradiation time of 200 hours, and filter: direct sunlight filter (Daylight-Q)) was conducted on the recording medium using a xenon arc tester (manufactured by Q-Lab Corporation, Q-SUN Xe-1), and then the average OD of each of the colored portion and the uncolored portion of the recording medium was obtained again. Next, regarding the colored portion and the uncolored portion, the OD maintenance rate before and after the light resistance test was obtained using the following formula.

(The OD maintenance rate before and after the light resistance) [%]=((The average OD after the light resistance test)/(The average OD before the light resistance test))×100

Note that the average OD before the light resistance test and the average OD after the light resistance test were obtained by a procedure similar to that in the above “Evaluation of OD in standard environment”.

Next, the OD maintenance rate of the colored portion before and after the light resistance test was evaluated in the following stages. The evaluation results are shown in Table 2.

Evaluation 2: The OD maintenance rate of the colored portion before and after the light resistance test is 85% or more.

Evaluation 1: The OD maintenance rate of the colored portion before and after the light resistance test is less than 85%.

Since the change from the original color is generally noticeable to anyone when the OD maintenance rate of the colored portion before and after the light resistance test is less than 85%, the reference value for determination in the two-stage evaluation was set to 85% of the OD maintenance rate.

Next, the OD maintenance rate of the uncolored portion before and after the light resistance test was evaluated in the following two stages. The evaluation results are shown in Table 2.

Evaluation 2: The OD maintenance rate of the colored portion before and after the light resistance test is 115% or less.

Evaluation 1: The OD maintenance rate of the colored portion before and after the light resistance test is larger than 115%.

Since the change from the original color is generally noticeable to anyone when the OD maintenance rate of the uncolored portion before and after the light resistance test is larger than 115%, the reference value for determination in the two-stage evaluation was set to 115% of the OD maintenance rate.

TABLE 1

| | | | | | | | | | | Converted value |
|---|---|---|---|---|---|---|---|---|---|---|
| | | | | | | | | | | [Conversion for |
| | | | | | | | Experimental | | | film thickness |
| | | | | | | | value | | | of 5 μm] |
| | | Color developer | | | | | | Average | Average | Average |
| | Leuco | | | | Raw | Melting | Film | OD of | OD of | OD of |
| | dye | | z¹¹, | | material | point | thick- | [symbol] | [symbol] | [symbol] |
| | Type | Type | z¹² | x¹ | of acid | [° C.] | ness | portion | portion | portion |
| Exam- | Magenta | Formula(2A) | Urea | Formula [symbol] | 4-aminophenol | 287 | 5.2 | 2.06 | 0.30 | 1.98 |
| ple 1 | | | | | | | | | | |
| Exam- | Magenta | Formula(3A) | Urea | Formula [symbol] | 4-aminophenol | 329 | 5.6 | 2.09 | 0.13 | 1.87 |
| ple 2 | | | | | | | | | | |
| Exam- | Magenta | Formula(4A) | Urea | Formula [symbol] | 4-aminophenol | 330 | 6.2 | 1.73 | 0.27 | 1.40 |
| ple 3 | | | | | | | | | | |
| Exam- | Magenta | Formula(5A) | Urea | Formula [symbol] | 3-aminophenol | 303 | 5.5 | 2.04 | 0.21 | 1.85 |
| ple 4 | | | | | | | | | | |
| Exam- | Magenta | Formula(6A) | Urea | Formula [symbol] | 4-aminophenol | 368 | 6.3 | 1.03 | 0.19 | 0.82 |
| ple 5 | | | | | | | | | | |
| Exam- | Magenta | Formula(7A) | Urea | Formula [symbol] | 4-amino- | 265 | 4.0 | 2.00 | 0.14 | 2.50 |
| ple 6 | | | | | 2-fluorophenol | | | | | |
| Exam- | Magenta | Formula(8A) | Urea | Formula [symbol] | 4-amino-o- | 308 | 4.0 | 1.33 | 0.15 | 1.66 |
| ple 7 | | | | | cresol | | | | | |
| Exam- | Magenta | Formula(9A) | Urea | Formula [symbol] | Methyl 5- | 298 | 4.5 | 1.14 | 0.16 | 1.27 |
| ple 8 | | | | | aminosalicyista | | | | | |
| Exam- | Magenta | Formula(10A) | Urea | Formula [symbol] | 4-aminophenol | 324 | 5.0 | 2.12 | 0.17 | 2.12 |
| ple 9 | | | | | | | | | | |
| Exam- | Yellow | Formula(3A) | Urea | Formula [symbol] | 4-aminophenol | 329 | 5.5 | 1.87 | 0.22 | 1.70 |
| ple 10 | | | | | | | | | | |
| Exam- | Cyan | Formula(3A) | Urea | Formula [symbol] | 4-aminophenol | 329 | 5.0 | 1.80 | 0.22 | 1.80 |
| ple 11 | | | | | | | | | | |
| Exam- | Cyan | Formula(3A) | Urea | Formula [symbol] | 4-aminophenol | 329 | 4.5 | 1.68 | 0.18 | 1.87 |
| ple 12 | | | | | | | | | | |
| Comparative | Magenta | Formula(1B) | Urea | C [symbol] ₁₂ | 4- | 231 | 5.2 | 1.62 | 0.32 | 1.56 |
| Example 1 | | | | | aminosalicylic | | | | | |
| | | | | | acid | | | | | |
| Comparative | Magenta | Formula(2B) | Urea | C [symbol] H₁₃ | 3-aminophenol | 225 | 4.5 | 1.47 | 0.23 | 1.40 |
| Example 2 | | | | | | | | | | |
| Comparative | Magenta | Formula(3B) | Urea | C [symbol] H₁₂ | 4-aminophenol | 235 | 5.4 | 1.76 | 0.15 | 1.63 |
| Example 3 | | | | | | | | | | |
| Comparative | Magenta | Formula(4B) | Urea | C [symbol] H₁₂ | Methyl 5- | 251 | 5.5 | 0.40 | 0.12 | 0.36 |
| Example 4 | | | | | aminosalicylate | | | | | |

| | | | High-temperature | | High-temperature | | | | | |
|---|---|---|---|---|---|---|---|---|---|---|
| | Converted value | | and low-humidity | | and high-humidity | | | | | |
| | [Conversion for | | storage stability | | storage stability | | | | | |
| | film thickness | | (80° C., 30% RH) | | (80° C., 60% RH) | | Heat-resistance | | Heat-resistance | |
| | of 5 μm] | | OD | | OD | | (1) | | (2) | |
| | Average | | mainte- | | mainte- | | (150° C., | | (180° C., | |
| | OD of | | nance | | nance | | 30 min) | | 5 min) | |
| | [symbol] | Evalu- | rate | Evalu- | rate | Evalu- | | Evalu- | | Evalu- |
| | portion | ation | [%] | ation | [%] | ation | ΔEab* | ation | ΔEab [symbol] | ation |
| Exam- | 0.29 | 2 | >95 | 2 | >95 | 2 | 5 | 2 | — | — |
| ple 1 | | | | | | | | | | |
| Exam- | 0.11 | 2 | >95 | 2 | >95 | 2 | 1 | 3 | [symbol] | 3 |
| ple 2 | | | | | | | | | | |
| Exam- | 0.22 | 2 | >95 | 2 | >95 | 2 | 5 | 2 | — | — |
| ple 3 | | | | | | | | | | |
| Exam- | 0.19 | 2 | >95 | 2 | >95 | 2 | 2 | 3 | 2 | 3 |
| ple 4 | | | | | | | | | | |
| Exam- | 0.15 | 2 | >95 | 2 | >85 | 2 | 3 | 3 | 3 | 3 |
| ple 5 | | | | | | | | | | |
| Exam- | 0.18 | 2 | >95 | 2 | >85 | 2 | 3 | 3 | 3 | 3 |
| ple 6 | | | | | | | | | | |
| Exam- | 0.19 | 2 | >95 | 2 | [symbol] | 2 | 1 | 3 | [symbol] | 3 |
| ple 7 | | | | | | | | | | |
| Exam- | 0.18 | 2 | >95 | 2 | >95 | 2 | 3 | 3 | 2 | 3 |
| ple 8 | | | | | | | | | | |
| Exam- | 0.17 | 2 | >95 | 2 | >95 | 2 | 1 | 3 | [symbol] | 3 |
| ple 9 | | | | | | | | | | |
| Exam- | 0.20 | [symbol] | >95 | 2 | [symbol] | 2 | 1 | 3 | [symbol] | 3 |
| ple 10 | | | | | | | | | | |
| Exam- | 0.22 | 2 | >95 | 2 | >95 | 2 | 1 | 3 | [symbol] | 3 |
| ple 11 | | | | | | | | | | |
| Exam- | 0.20 | 2 | >95 | 2 | >95 | 2 | [symbol] | 3 | 1 | 3 |
| ple 12 | | | | | | | | | | |
| Comparative | 0.31 | [symbol] | >95 | 2 | >85 | 2 | 1 | 3 | [symbol] | 3 |
| Example 1 | | | | | | | | | | |
| Comparative | 0.34 | 1 | <50 | 1 | <50 | 1 | 11 | 1 | 11 | 1 |
| Example 2 | | | | | | | | | | |
| Comparative | 0.14 | 2 | <50 | 1 | — | — | — | — | — | — |
| Example 3 | | | | | | | | | | |
| Comparative | 0.11 | 2 | <50 | 1 | <50 | 1 | — | — | — | — |
| Example 4 | | | | | | | | | | |

[symbol]

indicates data missing or illegible when filed

TABLE 2

| | Color developer | | | | | Photo- | |
|---|---|---|---|---|---|---|---|
| | | | | Raw | | thermal | |
| | | z¹¹, | | material | Coloring | conversion | Matrix |
| | Type | z¹² | x¹ | of acid | compound | agent | resin |
| Exam- | Formula | Urea | Formula | 4- | Magenta | Phthalo- | PC |
| ple 2 | (3A) | | (5) | aminophenol | | cyanine | |
| Exam- | | | | | | | PVC |
| ple 13 | | | | | | | |

| | | | | | High-temperature | | High-temperature | |
|---|---|---|---|---|---|---|---|---|
| | Light | | Light | | and low-humidity | | and high-humidity | |
| | resistance of | | resistance of | | storage stability | | storage stability | |
| | colored portion | | uncolored portion | | (80° C., 30% RH) | | (80° C., 60% RH) | |
| | OD | | OD | | OD | | OD | |
| | mainte- | | mainte- | | mainte- | | mainte- | |
| | nance | | nance | | nance | | nance | |
| | rate | Evalu- | rate | Evalu- | rate | Evalu- | rate | Evalu- |
| | [%] | ation | [%] | ation | [%] | ation | [%] | ation |
| Exam- | >95 | 2 | >95 | 2 | >95 | 2 | >95 | 2 |
| ple 2 | | | | | | | | |
| Exam- | >95 | 2 | >120 | 1 | >95 | 2 | >95 | 2 |
| ple 13 | | | | | | | | |

In Table 1, Z¹¹, Z¹², and X¹ represent symbols in the above formula (1).

In Table 1, in the evaluation result column of the OD maintenance rate, “>95”, “>85”, and “<50” show the following evaluation results.

>95: The Evaluation Result of the OD Maintenance rate is larger than 95%.

>85: The evaluation result of the OD maintenance rate is larger than 85% and 95% or less.

>50: The evaluation result of the OD maintenance rate is less than 50%.

In Table 2, in the evaluation result column of the OD maintenance rate, “>120” and “>95” show the following evaluation results.

>120: The evaluation result of the OD maintenance rate is larger than 120%.

>95: The evaluation result of the OD maintenance rate is larger than 95% and 120 or less.

In Table 1, the compounds of the formulae (2A) to (10A) and the formulae (1B) to (4B) are as follows.

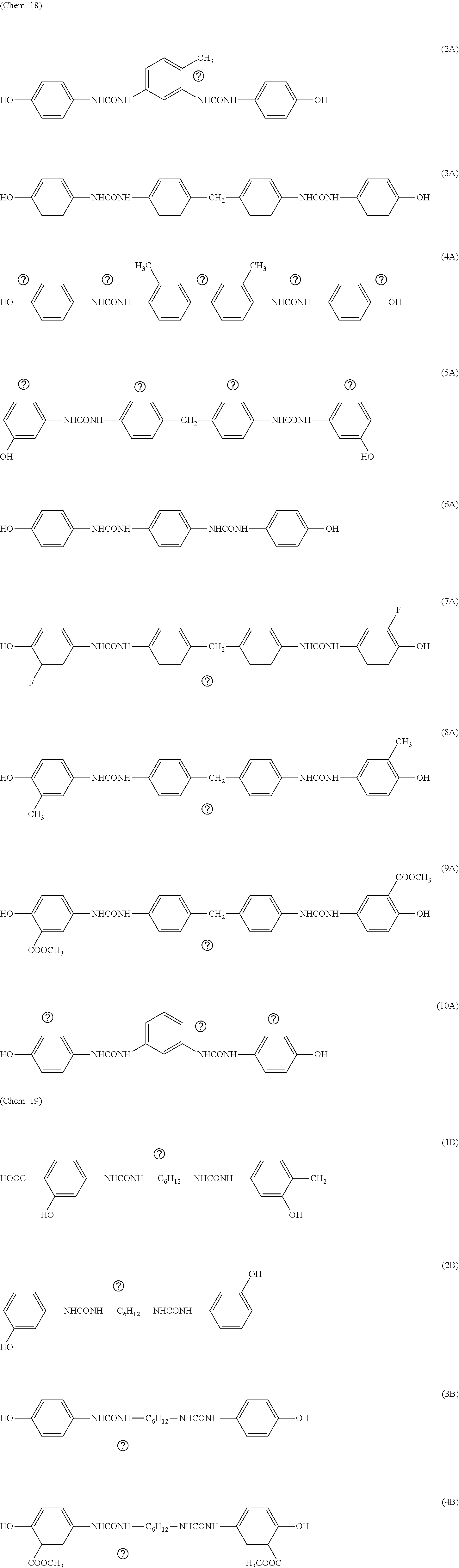

The following can be seen from Table 1. When the recording layer includes the compound represented by the formula (1) as a color developer, it is possible to improve both high-temperature and low-humidity preservation characteristics and high-temperature and high-humidity preservation characteristics and suppress coloration of a background. Further, it is also possible to improve heat resistance.

The following can be seen from Table 2. When the recording layer includes polycarbonate as a matrix resin, it is possible to improve the light resistance of the background of the recording medium.

### REFERENCE SIGNS LIST

10, 10A, 10B, 26, 33 recording medium
11, 21, 31 base material
12, 12A, 12B, 12C, 15 recording layer
13 protective layer
14A, 14B thermal insulation layer
15A, 15B, 15C microcapsule
20, 20A stacked body
22, 24 adhesive layer
23 intermediate layer
23A housing unit
25, 35 overlay layer
32, 34 bonding layer
41 sheet
110 print surface
120A back surface
120B surface
121 IC chip
122 face photo
210 display portion
220 non-display portion
230 casing
310 compartment
320 handle
411 bonnet
412 bumper
413 roof
414 trunk cover
415 front door
416 rear door
417 rear bumper
510 housing portion
520 lid
610 recording medium with adhesion layer
620 release sheet
611 adhesion layer
612 nail sticker portion

1. A recording medium, comprising:
a recording layer that includes a coloring compound with electron-donating properties and a color developer with electron acceptability,
the color developer including a compound represented by the following formula (1). 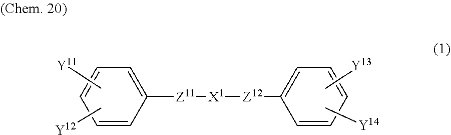
(wherein, in the formula (1), X¹ represents a divalent group that has at least one benzene ring. Y¹¹, Y¹², Y¹³, and Y¹⁴ independently represent a monovalent group. Z¹¹ and Z¹² independently represent a hydrogen-bonding group.)

2. The recording medium according to claim 1, wherein
the recording layer further includes a polycarbonate resin.

3. The recording medium according to claim 1, wherein
Z¹¹ and Z¹² in the formula (1) independently represent a urea bond (—NHCONH—), an amide bond (—NHCO—, —OCHN—), or a hydrazide bond (—NHCOCONH—).

4. The recording medium according to claim 1, wherein
Z¹¹ and Z¹² in the formula (1) represent a urea bond (—NHCONH—).

5. The recording medium according to claim 1, wherein
Y¹¹ and Y¹³ in the formula (1) represent a hydroxy group (—OH).

6. The recording medium according to claim 1, wherein
X¹ in the formula (1) represents a divalent group having at least two benzene rings.

7. The recording medium according to claim 1, wherein
each of a benzene ring having Y¹¹ and Y¹² and/or a benzene ring having Y¹² and Y¹³ in the formula (1) is a weak acid.

8. The recording medium according to claim 1, wherein
X¹ in the formula (1) represents a divalent group represented by the following formula (3). 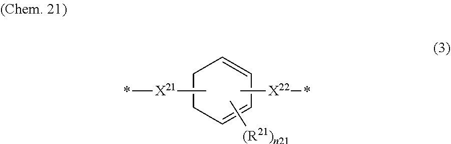
(wherein, in the formula (3), X²¹ does not necessarily need to be present and represents a divalent group when X²¹ is present. X²² does not necessarily need to be present and represents a divalent group when X²² is present. R²¹ represents a monovalent group. n21 represents an integer from 0 to 4. When n21 represents an integer from 2 to 4, each R²¹ may be the same or different. A mark * represents a bonding portion.)

9. The recording medium according to claim 1, wherein
X¹ in the formula (1) represents a divalent group represented by the following formula (4). 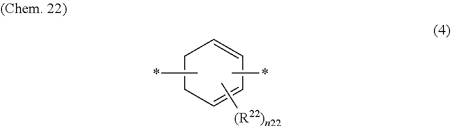
(wherein, in the formula (4), R²² represents a monovalent group. n22 represents an integer from 0 to 4. When n22 represents an integer from 2 to 4, each R²² may be the same or different. A mark * represents a bonding portion.)

10. The recording medium according to claim 1, wherein
X¹ in the formula (1) represents a divalent group represented by the following formula (5). 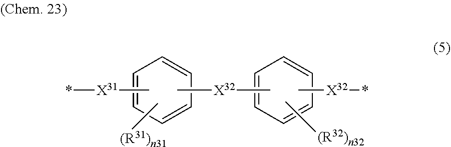
(wherein, in the formula (5), X³¹ does not necessarily need to be present and represents a divalent group when X³¹ is present. X³² does not necessarily need to be present and represents a divalent group when X³² is present. X³³ does not necessarily need to be present and represents a divalent group when X³³ is present. R³¹ and R³² independently represent a monovalent group. n31 and n32 independently represent an integer from 0 to 4. When n31 represents an integer from 2 to 4, R³¹ may be the same or different. When n32 represents an integer from 2 to 4, R³² may be the same or different. A mark * represents a bonding portion.)

11. The recording medium according to claim 1, wherein
X¹ in the formula (1) represents a divalent group represented by the following formula (6). 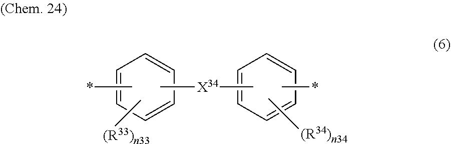
(wherein, in the formula (6), X³⁴ represents a divalent group. R³³ and R³⁴ independently represent a monovalent group. n33 and n34 independently represent an integer from 0 to 4. When n33 represents an integer from 2 to 4, R³³ may be the same or different. When n34 represents an integer from 2 to 4, R³⁴ may be the same or different. A mark * represents a bonding portion.)

12. The recording medium according to claim 1, wherein
the recording layer includes a plurality of recording layers, and
the coloring compound included in each of the plurality of recording layers is capable of exhibiting a different hue in a colored state.

13. The recording medium according to claim 12, wherein
each of the plurality of recording layers includes a photothermal conversion agent, and
the photothermal conversion agent included in each of the plurality of recording layers has a different absorption wavelength peak.

14. The recording medium according to claim 1, wherein
the recording layer includes a plurality of types of capsules,
each of the plurality of types of capsules includes the coloring compound and the color developer, and
the coloring compound included in each of the plurality of types of capsules is capable of exhibiting a different hue in a colored state.

15. The recording medium according to claim 14, wherein
the plurality of types of capsules includes a photothermal conversion agent, and
the photothermal conversion agent included in each of the plurality of types of capsules has a different absorption wavelength peak.

16. A recording medium, comprising:
a recording layer that includes a coloring compound with electron-donating properties and a color developer with electron acceptability,
the color developer including a compound represented by the following formula (a). 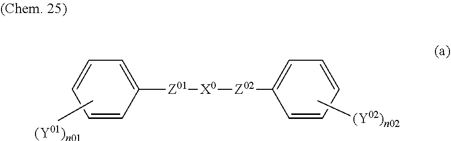
(wherein, in the formula (a), X⁰ represents a divalent group that has at least one benzene ring. Y⁰¹ and Y⁰² independently represent a monovalent group. n01 and n02 independently represent an integer from 0 to 5. When n01 represents an integer from 2 to 5, each Y⁰¹ may be the same or different. When n02 represents an integer from 2 to 5, Y⁰² may be the same or different. Z⁰¹ and Z⁰² independently represent a hydrogen-bonding group.)

17. A card, comprising:
the recording medium according to claim 1.

18. A booklet, comprising:
the recording medium according to claim 1.
